(19) United States
(12) Patent Application Publication
(10) Pub. No.: US 2013/0067463 A1
(43) Pub. Date: Mar. 14, 2013

(54) INFORMATION PROCESSING DEVICE, PROGRAM INSTALLATION SUPPORT METHOD, AND COMPUTER-READABLE RECORDING MEDIUM

(71) Applicant: Tatsuo Ito, Kanagawa (JP)

(72) Inventor: Tatsuo Ito, Kanagawa (JP)

(21) Appl. No.: 13/700,452

(22) PCT Filed: Jun. 2, 2011
(86) PCT No.: PCT/JP2011/063189

§ 371 Date: Nov. 28, 2012

(30) Foreign Application Priority Data
Jun. 3, 2010 (JP) 2010-127686

(51) Int. Cl. G06F 9/445; G06F 15/16

(52) U.S. Cl. 717/178

(57) ABSTRACT

An information processing device performs communications via a network with a management device storing dependency information indicating a dependency relationship between programs. The information processing device includes a sending unit that sends, to the management device, identification information of a program to be downloaded; a receiving unit that receives, from the management device, install possibility information indicating whether the program to be downloaded can be installed in the information processing device, the install possibility information being determined based on the dependency information; and a display control unit that causes a display unit to display a screen page indicating whether the program to be downloaded can be installed in the information processing device based on the install possibility information, before downloading the program to be downloaded.

### TECHNICAL FIELD

The present invention relates to an information processing device, a program installation support method, and a computer-readable recording medium, and more particularly to an information processing device, a program installation support method, and a computer-readable recording medium for managing licenses of programs used in devices.

### BACKGROUND ART

In recent years and continuing, for image forming apparatuses referred to as multifunction peripherals or multifunction devices, new programs can be developed and installed after shipment (see, for example, patent document 1). By installing such programs, users can relatively easily expand functions of the image forming apparatus to meet their respective purposes.

However, there may be cases where the program to be installed depends on another program (dependency relationship between programs), but the other program that is depended upon is not distributed together with the program to be installed in a single package. In this case, even if a program is installed, the other program on which this program depends is not installed, and therefore the installed program may not operate properly. Furthermore, the dependency relationships between the programs may extend across plural tiers. In this case, the user needs to bear the load of solving the dependency relationships between the programs.
Patent Document 1: Japanese Laid-Open Patent Application No. 2008-016013

### DISCLOSURE OF INVENTION

The present invention has been made in view of the above-described problems, and it is an object of at least one embodiment of the present invention to provide an information processing device, a program installation support method, and a computer-readable recording medium that can appropriately support the operation of installing a program.

An aspect of the present invention provides an information processing device that performs communications via a network with a management device storing dependency information indicating a dependency relationship between programs, the information processing device including a sending unit that sends, to the management device, identification information of a program to be downloaded; a receiving unit that receives, from the management device, install possibility information indicating whether the program to be downloaded can be installed in the information processing device, the install possibility information being determined based on the dependency information; and a display control unit that causes a display unit to display a screen page indicating whether the program to be downloaded can be installed in the information processing device based on the install possibility information, before downloading the program to be downloaded.

An aspect of the present invention provides a program installation support method performed by an information processing device that performs communications via a network with a management device storing dependency information indicating a dependency relationship between programs, the program installation support method including sending, to the management device, identification information of a program to be downloaded; receiving, from the management device, install possibility information indicating whether the program to be downloaded can be installed in the information processing device, the install possibility information being determined based on the dependency information; and causing a display unit to display a screen page indicating whether the program to be downloaded can be installed in the information processing device based on the install possibility information, before downloading the program to be downloaded.

An aspect of the present invention provides a computer-readable recording medium storing a program installation support program that causes an information processing device to execute a procedure, the information processing device performing communications via a network with a management device storing dependency information indicating a dependency relationship between programs, the procedure including sending, to the management device, identification information of a program to be downloaded; receiving, from the management device, install possibility information indicating whether the program to be downloaded can be installed in the information processing device, the install possibility information being determined based on the dependency information; and causing a display unit to display a screen page indicating whether the program to be downloaded can be installed in the information processing device based on the install possibility information, before downloading the program to be downloaded.

### BRIEF DESCRIPTION OF DRAWINGS

FIG. 1 illustrates an example of a configuration of a device management system according to a first embodiment;

FIG. 2 illustrates an example of a configuration of a sales package;

FIG. 3 illustrates an example of a configuration of sales package information;

FIG. 4 illustrates an example of a configuration of function package information;

FIG. 5 illustrates an example of a functional configuration of the device management system according to the first embodiment;

FIG. 6 illustrates an example of a hardware configuration of a license management server according to an embodiment of the present invention;

FIG. 7 illustrates an example of a hardware configuration of an image forming apparatus according to an embodiment of the present invention;

FIG. 8 is a sequence diagram for describing a process of acquiring list information of sales packages performed by a sales server;

FIG. 9 illustrates an example of a configuration of a sales site master;

FIG. 10 illustrates an example of a configuration of a sales package master;

FIG. 11 illustrates an example of a configuration of a group ID master;

FIG. 12 is a flowchart for describing process procedures of a process of registering article information in an article master;

FIG. 13 illustrates an example of a configuration of an article master in a sales server;

FIG. 14 is a sequence diagram for describing process procedures performed when an article is sold;

FIG. 15 is a flow chart for describing process procedures of a product key generating process performed by a product key issue unit;

FIG. 16 illustrates an example of a configuration of a license management table;

FIG. 17 illustrates an example of a configuration of a product key;

FIG. 18 is a sequence diagram for describing process procedures performed when installing a sales package;

FIG. 19 illustrates a display example of a function expansion setting menu screen page;

FIG. 20 illustrates a display example of a product key enter screen page;

FIG. 21 illustrates a display example of an error screen page when the product key is invalid;

FIG. 22 illustrates an example of a configuration of a component management table;

FIG. 23 illustrates a display example of an install list screen page;

FIG. 24 illustrates an example of a configuration of an install information management table;

FIG. 25 illustrates a display example of a confirmation screen page when there is no problem with the dependency relationship;

FIG. 26 illustrates a display example of a confirmation screen page when a dependency package can be simultaneously installed;

FIG. 27 illustrates a display example of a confirmation screen page when a dependency package cannot be simultaneously installed;

FIG. 28 illustrates an example of a configuration of a license file;

FIG. 29 is a flowchart for describing process procedures of a process of verifying the dependency relationship and a process of generating confirmation screen page data, performed by a component server unit;

FIG. 30 illustrates an example of a configuration of a dependency relationship management table;

FIG. 31 is a flowchart for describing processing procedures of a license file generation process performed by an activation server unit;

FIG. 32 is a flowchart for describing process procedures of a process of installing a sales package performed by the image forming apparatus;

FIG. 33 is a sequence diagram for describing process procedures of a license update process;

FIG. 34 illustrates a display example of a function expansion management screen page;

FIG. 35 illustrates a display example of a license acquire/update screen page;

FIG. 36 is a sequence diagram for describing process procedures of a sales package update process;

FIG. 37 illustrates a display example of an update list screen page;

FIG. 38 is a sequence diagram for describing process procedures of a deactivation process;

FIG. 39 is a flowchart for describing process procedures of a process of automatically executing deactivation in the image forming apparatus;

FIG. 40 illustrates an example of a configuration of a device management system according to a second embodiment;

FIG. 41 illustrates an example of a functional configuration of a device management apparatus according to the second embodiment;

FIG. 42 is a sequence diagram for describing process procedures of installing and activating a sales package according to the second embodiment;

FIG. 43 is a sequence diagram for describing process procedures of uninstalling and deactivating a sales package according to the second embodiment;

FIG. 44 illustrates an example of a configuration of a device management system according to a third embodiment; and

FIG. 45 illustrates an example of a functional configuration of the device management system according to the third embodiment.

### BEST MODE FOR CARRYING OUT THE INVENTION

Embodiments of the present invention are described below with reference to the accompanying drawings.

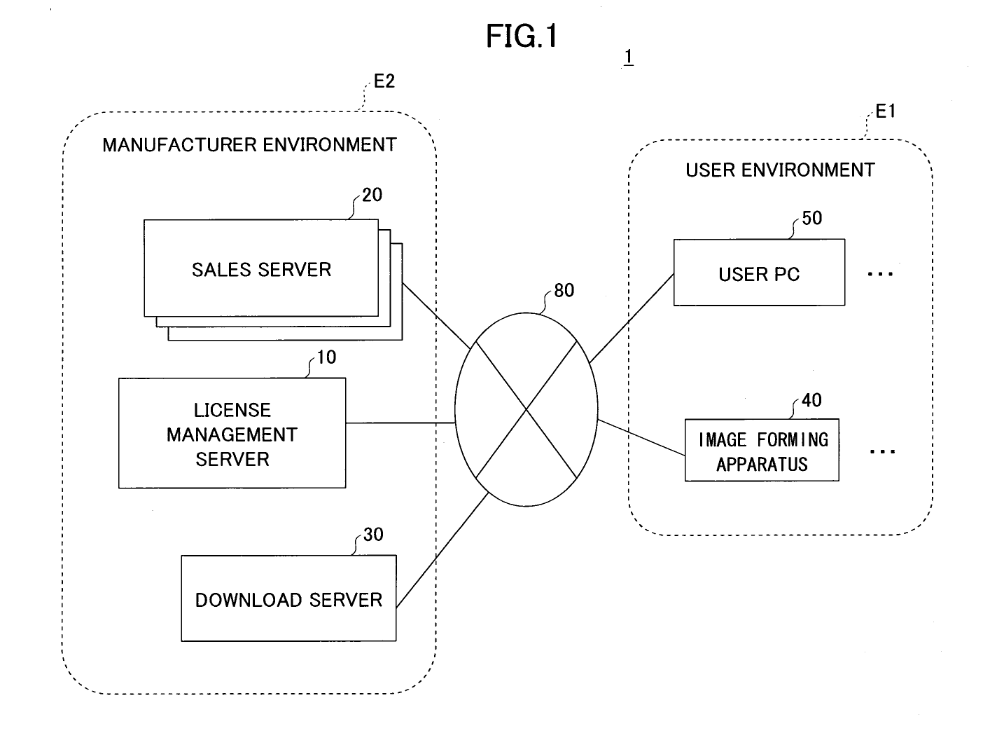

FIG. 1 illustrates an example of a configuration of a device management system according to a first embodiment. A device management system 1 shown in FIG. 1 is broadly divided into a user environment E1 and a manufacturer environment E2. The user environment E1 and the manufacturer environment E2 are connected via a wide area network 80 such as the Internet.

The user environment E1 is a system environment of a user (client) of an image forming apparatus 40 into which programs are to be installed. For example, the user environment E1 corresponds to a company or an office that is the user of the image forming apparatus 40. The user environment E1 includes at least one image forming apparatus 40 and at least one user PC 50. The image forming apparatus 40 is a multifunction peripheral including plural functions of printing, scanning, copying, and fax transmission, provided in a single unit. However, the image forming apparatus 40 may only have one of these functions. Functions of the image forming apparatus 40 may be expanded according to need by adding or updating software components (hereinafter, simply referred to as “components”). The user PC 50 is used for making procedures to purchase components to be added to the image forming apparatus 40. There may be plural user environments E1 in accordance with the number of users (number or users in units of companies and offices).

Meanwhile, the manufacturer environment E2 is a system environment of a vendor of the components to be added to the image forming apparatus 40. For example, the manufacturer environment E2 is operated by the manufacturer of the image forming apparatus 40. The manufacturer environment E2 includes a license management server 10, a sales server 20, and a download server 30. The sales server 20 is a computer that receives purchase applications for components from the user environment E1. The sales server 20 is provided in each sales region (for example, the US, Europe, Japan, Asia excluding Japan, etc.) of the image forming apparatus 40, and each sales server 20 receives purchase applications from user environments E1 belonging to the corresponding sales region.

The download server 30 is a computer for managing the entities of components. The user environment E1 downloads, from the download server 30, an entity of the component for which the purchase application has been submitted. The license management server 10 is a computer for managing a license (usage authority) of the purchased component. Components of the present embodiment are distributed in units of sales packages. Furthermore, components may be distributed in a set including a group of plural sales packages. A group of plural sales packages is simply referred to as a “group” in the present embodiment.

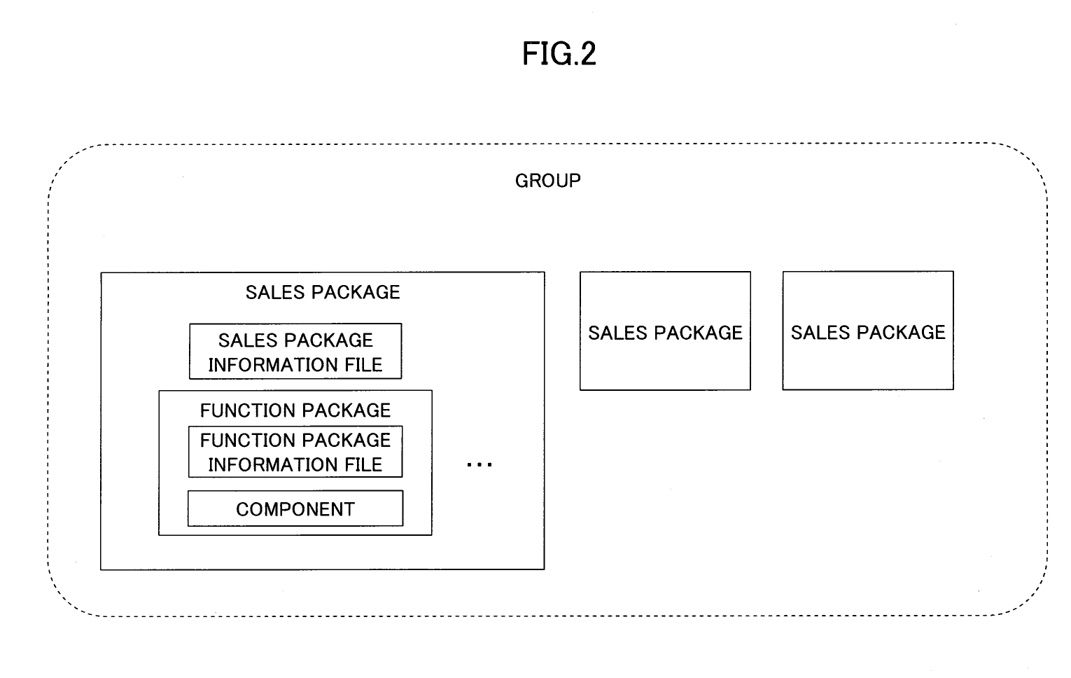

FIG. 2 illustrates an example of a configuration of a sales package. As shown in FIG. 2, each sales package is an archival file including one sales package information file and one or more function packages.

The sales package information file records attribute information of sales packages (sales package information).

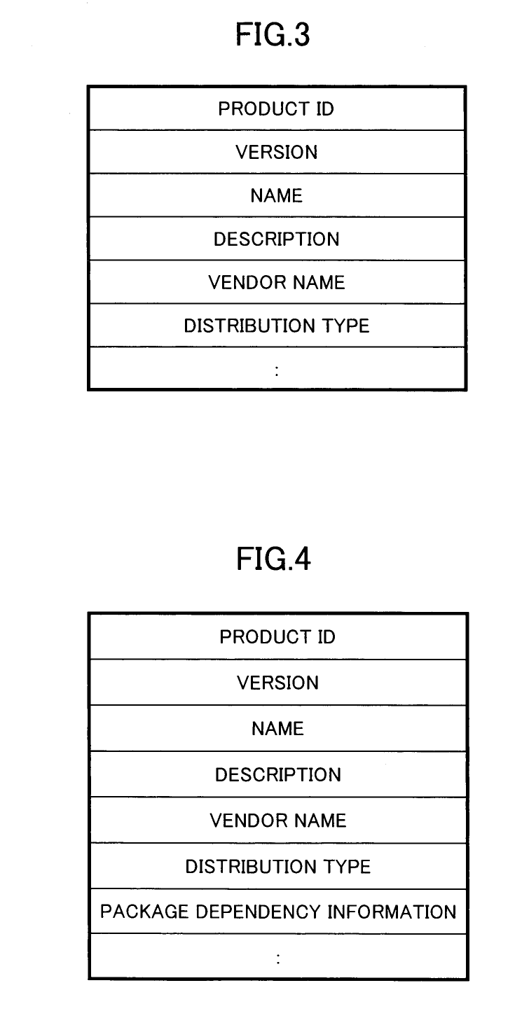

FIG. 3 illustrates an example of a configuration of sales package information. As shown in FIG. 3, the sales package information includes a product ID, a version, a name, a description, a vendor name, and a distribution type.

The product ID is an identifier (product identifier) uniquely assigned to each sales package and each function package. The version is a version number of the sales package. The name is the name of the sales package. The description is for describing the sales package. The vendor name is the name of the vendor (developer) of the sales package. The distribution type is information indicating whether the activation (license authentication) is necessary. A sales package that does not require activation can be used free of charge.

Referring back to FIG. 2, function packages are software packages that are packaged in units of functions. Each function package is an archival file (for example, a JAR (Java (registered trademark) Archive) file) including one function package information file and an entity of one component.

The function package information file records attribute information (function package information) of the function package.

FIG. 4 illustrates an example of a configuration of the function package information. As shown in FIG. 4, the function package information includes a product ID, a version, a name, a description, a vendor name, a distribution type, and package dependency information.

The product ID is the product ID of the function package. The version is a version number of the function package. The name is the name of the function package. The description is for describing the function package. The vendor name is the name of the vendor (developer) of the function package. The distribution type is information indicating whether it is necessary to perform activation (license authentication) on the function package. A function package that does not require activation can be used free of charge. The package dependency information is a product ID of another function package (depended upon by the corresponding function package) on which the corresponding function package depends (or uses). Each function package may depend on a plurality of other function packages.

In FIG. 2, three sales packages form a group. A sales package may be distributed alone even if it belongs to a group.

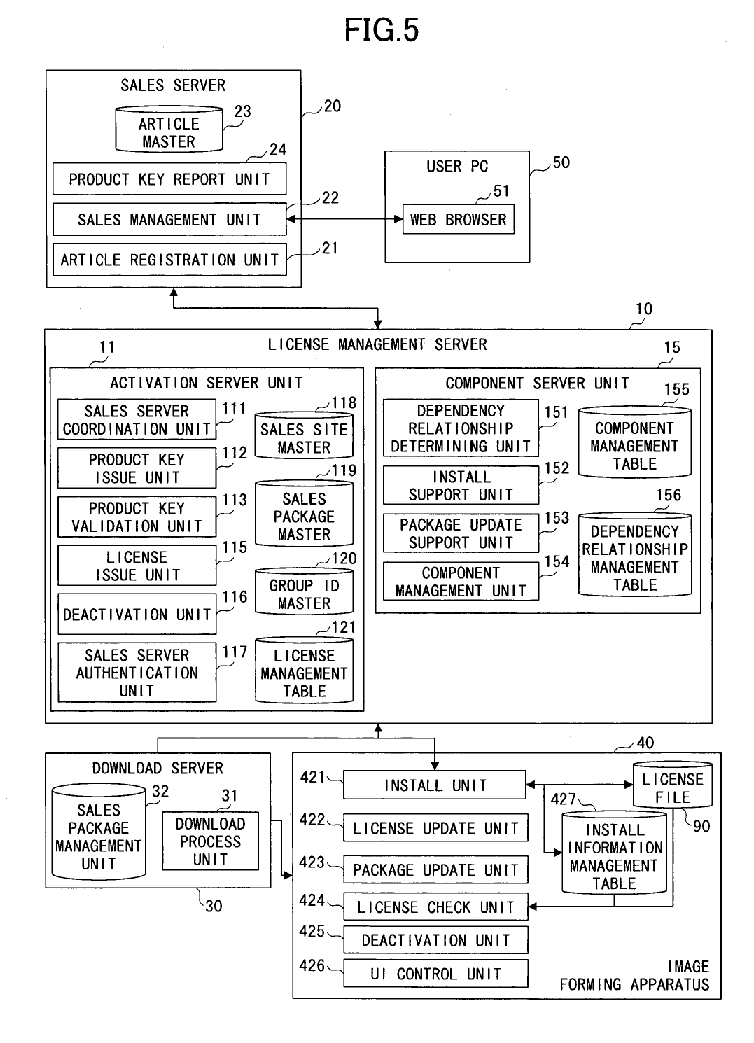

FIG. 5 illustrates an example of a functional configuration of the device management system 1 according to the first embodiment. As shown in FIG. 5, the sales server 20 includes an article registration unit 21, a sales management unit 22, a product key report unit 24, and an article master 23.

The article registration unit 21 downloads information indicating a list of sales packages that are integrally managed in the license management server 10. Based on this list, the article registration unit 21 registers, in the article master 23, article configuration information entered by an operator. The sales management unit 22 receives purchase applications from the user PC 50, for articles having article information registered in the article master 23. The sales management unit 22 causes the license management server 10 to issue a product key for the purchase application. The product key report unit 24 transmits the issued product key to the user PC 50, as a response to the purchase application.

In the present embodiment, an article is a concept including a sales package or a group, and contents of the license of the sales package or group. Therefore, even if two sales packages are the same, they may be handled as different articles if the contents of the licenses (license format, license validity period, the license volume number, etc.) are different. Hereinafter, information relevant to contents of the license is referred to as license information.

A product key is an identifier that is uniquely issued (or assigned) every time an article is purchased. A product key is used as information (license identifier) for identifying the license (usage authority) for a sales package included in an article, or as information for certifying a legitimate purchaser of the article. In the present embodiment, a product ID and a product key are clearly distinguished from one another. That is to say, product IDs are for determining whether sales packages are the same product or different products, while product keys are for distinguishing the acts of purchasing products. Therefore, different product keys are issued every time an article is purchased, even for sales packages having the same product ID.

The image forming apparatus 40 includes an install unit 421, a license update unit 422, a package update unit 423, a license check unit 424, a deactivation unit 425, an UI control unit 426, and an install information management table 427.

The install unit 421 controls a series of processes for installing a sales package corresponding to a product key, when the product key is entered. For example, the install unit 421 requests the license management server 10 to determine the validity of a dependency relationship of a function package included in a sales package to be installed, downloads the sales package to be installed from the download server 30, and acquires, from the license management server 10, a license file 90 for the sales package to be installed.

The license file 90 is a file in which data (data for allowing usage of a sales package) for certifying a license for a sales package is recorded. That is to say, a sales package (component) according to the present embodiment cannot be used in the image forming apparatus 40 simply by obtaining the entity of the sales package. The sales package can be used by installing the license file 90 in the image forming apparatus 40.

The license update unit 422 controls a process (license update process) for updating (extending) the expiration date of a license for a sales package installed in the image forming apparatus 40. The package update unit 423 controls a process (sales package update process) for upgrading a sales package installed in the image forming apparatus 40. The license check unit 424 determines whether to authorize usage of a sales package based on the license file 90. The deactivation unit 425 deactivates a sales package installed in the image forming apparatus 40. Specifically, the deactivation unit 425 deletes a sales package determined as a target of deactivation and the license file 90 of the sales package. The UI control unit 426 controls the display of the operation panel of the image forming apparatus 40. The install information management table 427 is a table for managing information relevant to a sales package installed in the image forming apparatus 40, and the install information management table 427 is saved in a storage device of the image forming apparatus 40.

The license management server 10 includes an activation server unit 11 and a component server unit 15. The activation server unit 11 includes a sales server coordination unit 111, a product key issue unit 112, a product key verification unit 113, a license issue unit 115, a deactivation unit 116, a sales server authentication unit 117, a sales site master 118, a sales package master 119, a group ID master 120, and a license management table 121.

The sales server coordination unit 111 executes a process requested by the sales server 20 and a process in accordance with information reported from the sales server 20. The product key issue unit 112 generates a product key in response to a request from the sales management unit 22 of the sales server 20. The product key issue unit 112 registers, in the license management table 121, a generated product key and information relevant to a license identified with the generated product key. The product key verification unit 113 verifies the validity of a product key entered in the image forming apparatus 40 when downloading a sales package, based on the license management table 121.

The license issue unit 115 issues a license for a sales package. As a license is issued, the license management table 121 is updated, and the license file 90 is generated. The deactivation unit 116 releases a requested license, in response to a deactivation request from the deactivation unit 425 of the image forming apparatus 40. The sales server authentication unit 117 authenticates the sales server 20 with the use of the sales site master 118. In the sales package master 119, information indicating a list of sales packages is registered. In the group ID master 120, information indicating the association of groups and sales packages is registered. The sales site master 118, the sales package master 119, the group ID master 120, and the license management table 121 are saved in the storage device of the license management server 10.

The component server unit 15 includes a dependency relationship determining unit 151, an install support unit 152, a package update support unit 153, a component management unit 154, a component management table 155, and a dependency relationship management table 156. The dependency relationship determining unit 151 determines whether another function package that is depended upon by the function package included in the sales package to be installed or updated, is already installed in the image forming apparatus 40. More specifically, in response to a request from the install unit 421 of the image forming apparatus 40, the dependency relationship determining unit 151 determines whether the dependency relationship of a function package included in a sales package to be installed is satisfied by another function package already installed in the image forming apparatus 40. This determination is made by referring to the component management table 155 and the dependency relationship management table 156. The install support unit 152 performs a process for supporting the process of installing the sales package into the image forming apparatus 40. For example, the install support unit 152 generates HTML data (install list screen page data) for displaying a screen page with which a user can select a sales package to be installed, and provides the install list screen page data to the install unit 421 of the image forming apparatus 40. The package update support unit 153 performs a process for supporting the operation of updating (upgrading) a sales package in the image forming apparatus 40. For example, the package update support unit 153 generates HTML data (update list screen page data) for displaying a screen page with which a user can select a sales package to be updated, and provides the update list screen page data to the package update unit 423 of the image forming apparatus 40. The component management unit 154 periodically acquires sales packages saved in a sales package management unit 32 of the download server 30. Furthermore, the component management unit 154 registers, in the component management table 155 or the dependency relationship management table 156, configuration information of the sales package and dependency information of the respective function packages included in the sales package. The component management table 155 and the dependency relationship management table 156 are saved in the storage device of the license management server 10.

Each function package includes information indicating a function package on which it depends, and the license management server 10 registers, in the dependency relationship management table 156, the dependency relationship between function packages based on the information indicating a function package on which the function package depends. Accordingly, information relevant to complex dependency relationships can be easily registered. For example, when a function package manufactured by a manufacturer of function packages (or sales packages including function packages) is placed in the download server 30, the license management server 10 acquires package dependency information included in the function package from the download server 30, and automatically registers the dependency relationship between function packages in the dependency relationship management table 156. Therefore, for example, even when the administrator of the sales site and the manufacturer of the function package are different, the administrator of the sales site does not need to know the dependency relationship between function packages. Consequently, function packages can be manufactured by third vendors, and sales opportunities can be increased.

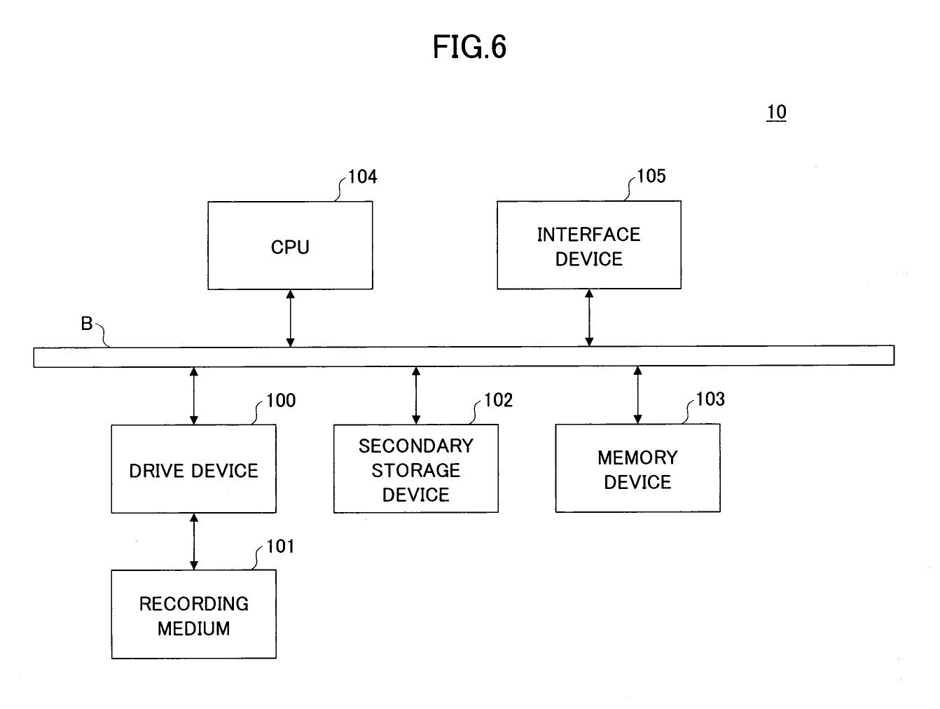

FIG. 6 illustrates an example of a hardware configuration of the license management server 10 according to an embodiment of the present invention. The license management server 10 includes a drive device 100, a secondary storage device 102, a memory device 103, a CPU 104, and an interface device 105, which are interconnected by a bus B.

A program for implementing a process at the license management server 10 is provided by a recording medium 101 such as a CD-ROM. When the recording medium 101 recording the program is set in the drive device 100, the program is installed in the secondary storage device 102, from the recording medium 101 via the drive device 100. However, a program does not always have to be installed from the recording medium 101; a program may be downloaded from another computer via a network. The secondary storage device 102 stores the installed program as well as necessary files and data.

The memory device 103 reads a program from the secondary storage device 102 and stores the program, when an instruction to activate the program is given. The CPU 104 implements functions (the respective units indicated in FIG. 5) relevant to the license management server 10, in accordance with the program stored in the memory device 103. The interface device 105 is used as an interface for connecting to a network.

The license management server 10 may include a display device such as a liquid crystal display or a CRT display, and an input device such as a keyboard and a mouse.

The sales server 20, the download server 30, and the user PC 50 may have the same hardware configurations as that illustrated in FIG. 6.

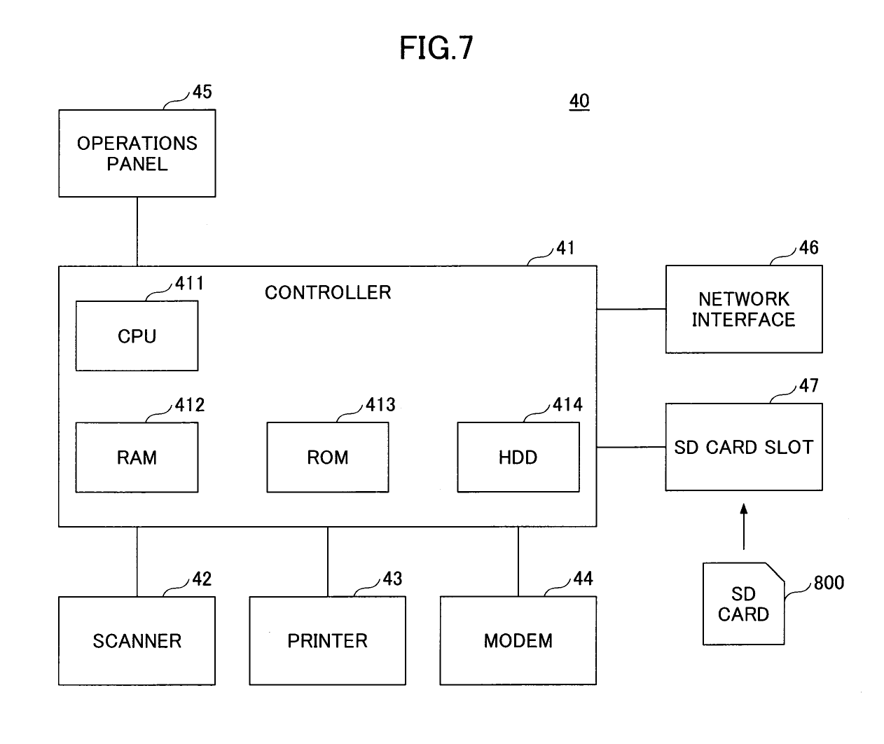

FIG. 7 illustrates an example of a hardware configuration of the image forming apparatus 40 according to an embodiment of the present invention. As shown in FIG. 7, the image forming apparatus 40 includes a controller 41, a scanner 42, a printer 43, a modem 44, an operations panel 45, a network interface 46, and an SD card slot 47.

The controller 41 includes a CPU 411, a RAM 412, a ROM 413, and a HDD 414. The ROM 413 records various programs and data used by the programs. The RAM 412 is used as a storage area for loading programs and a work area for the loaded programs. The CPU 411 implements various programs (the respective units indicated in FIG. 5) by processing the programs loaded in the RAM 412. The HDD 414 records various programs and data used by the programs.

The scanner 42 is a hardware component for reading image data from an original document. The printer 43 is a hardware component for printing image data onto a print sheet. The modem 44 is a hardware component for connecting to a telephone line, and is used for transmitting/receiving image data by fax transmission. The operations panel 45 is a hardware component including an input unit such as buttons for receiving input from a user, and a display unit such as a liquid crystal panel. The network interface 46 is a hardware component for connecting to a network (wired or wireless) such as LAN. The SD card slot 47 is used for reading programs recorded in an SD card 800. That is to say, in the image forming apparatus 40, not only programs recorded in the ROM 413 can be recorded in the RAM 412 and be executed, but also programs recorded in the SD card 800 can be recorded in the RAM 412 and be executed.

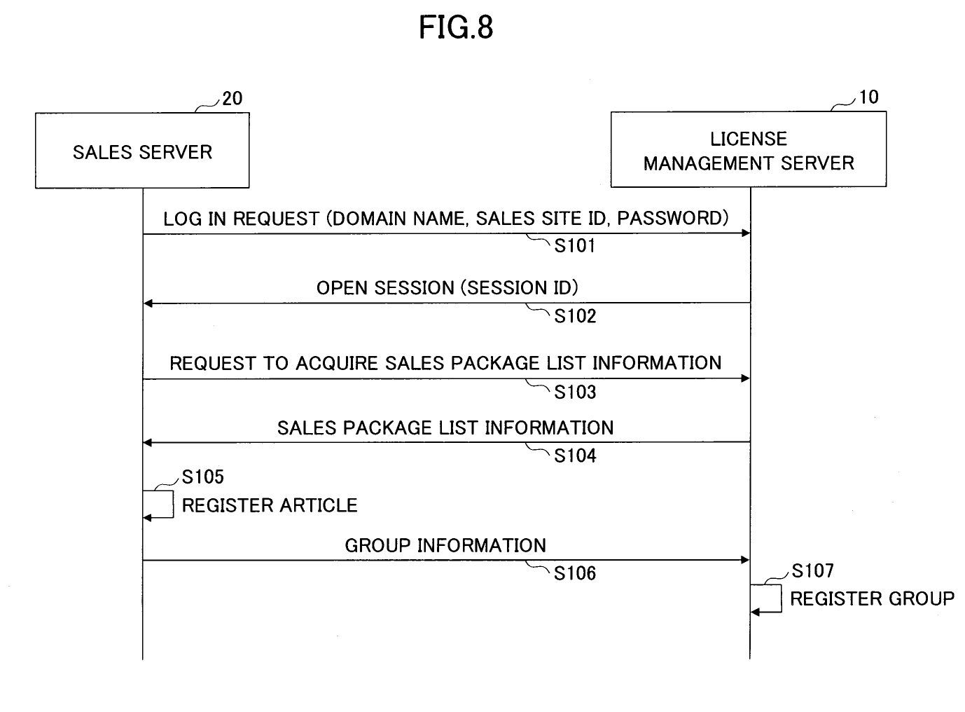

The following describes process procedures executed in the device management system 1 according to the first embodiment. FIG. 8 is a sequence diagram for describing a process of acquiring list information of sales packages performed by the sales server 20. Configurations of articles to be sold are determined by each sales region. The process of FIG. 8 is executed when the configuration of the article to be sold is determined in a certain sales region.

For example, when an administrator of a sales site enters an instruction to acquire article information in the sales server 20, the article registration unit 21 of the sales server 20 specifies the domain name, the sales site ID, and the password stored in the storage device of the sales server 20, and sends an authentication request to the activation server unit 11 of the license management server 10 (step S101).

When the authentication request is received, the sales server authentication unit 117 authenticates the sales server 20 based on the information specified in the authentication request and the sales site master 118.

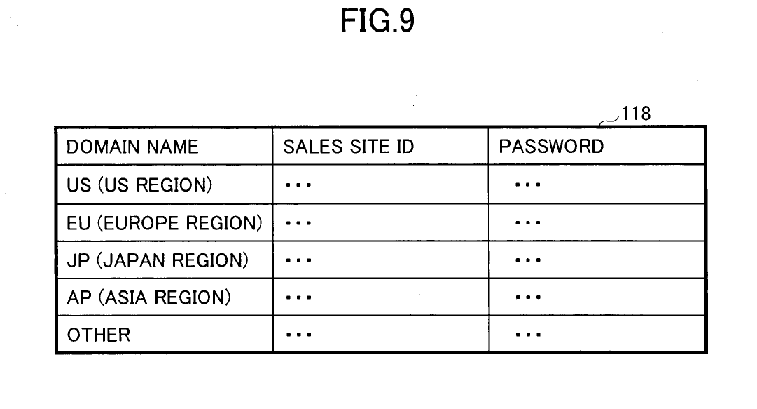

FIG. 9 illustrates an example of a configuration of the sales site master 118. As shown in FIG. 9, the sales site master 118 has a domain name, a sales site ID and a password registered for each sales region.

The sales server authentication unit 117 authenticates the sales server 20 by cross-checking the domain name, the sales site ID, and the password included in the authentication request with the domain name, the sales site ID, and the password included in the sales site master 118. When the authentication is successful, the sales server authentication unit 117 opens a session, and returns a session ID to the sales management unit 22 (step S102). Hereinafter, the communications between the sales management unit 22 and the activation server unit 11 are performed based on the session ID.

Next, the article registration unit 21 sends a request to acquire list information of sales packages, to the sales server coordination unit 111 of the activation server unit 11 (step S103). In response to receiving the request to acquire list information of sales packages, the sales server coordination unit 111 acquires the list information from the sales package master 119, and returns the list information to the article registration unit 21 (step S104).

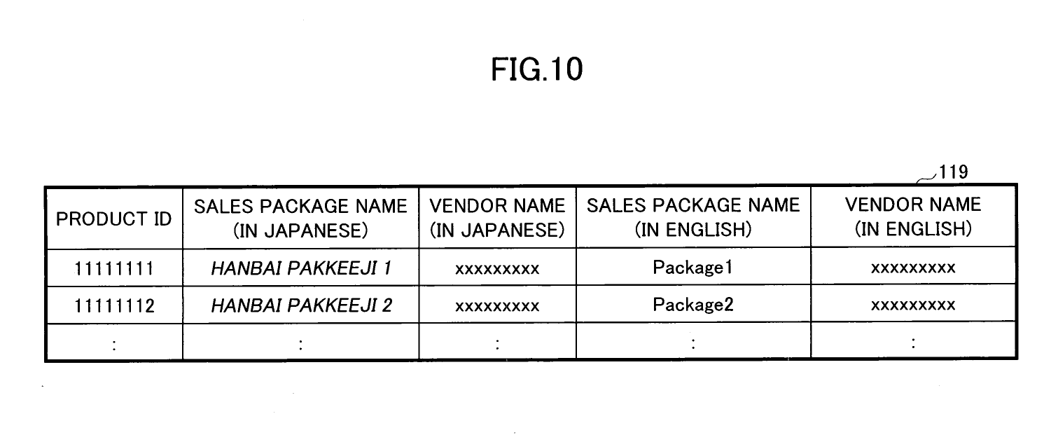

FIG. 10 illustrates an example of a configuration of the sales package master 119. As shown in FIG. 10, the sales package master 119 has a product ID, a sales package name in Japanese, a vendor name in English, a sales package name in English, and a vendor name in English registered for each sales package. The list information returned at step S104 includes these information items for each sales package. The information is registered in the sales package master 119 by, for example, an administrator of the license management server 10.

When the list information of sales packages is received, the article registration unit 21 registers, in the article master 23, information entered by an administrator of a sales site, based on the list information (step S105). According to need, the administrator may define a group. Specifically, a group ID is determined, and sales packages belonging to a group relevant to the group ID are determined. When a group is defined, the article registration unit 21 sends the defined group information (group ID and product IDs of sales packages belonging to the group) to the sales server coordination unit 111 (step S106). Subsequently, the sales server coordination unit 111 registers the received group information in the group ID master 120 (step S107).

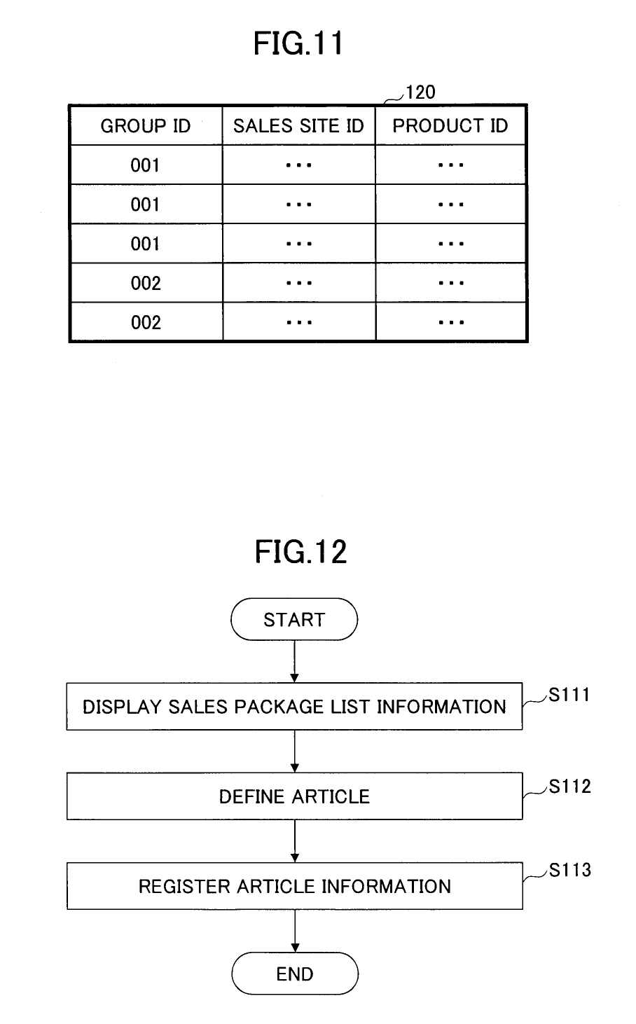

FIG. 11 illustrates an example of a configuration of the group ID master 120. As shown in FIG. 11, the group ID master 120 has a product ID of a sales package belonging to a group relevant to a group ID registered for each combination of a group ID and a sales site ID. A group ID is combined with a sales site ID because a group ID is unique to each sales site. In FIG. 11, there are plural records including the same group ID (for example, 001). The group ID master 120 of FIG. 11 has a product ID of one sales package registered in each record. That is to say, there are three sales packages belonging to the group having a group ID “001”.

Subsequently, details of step S105 are described. FIG. 12 is a flowchart for describing process procedures of a process of registering article information in the article master 23.

In step S111, the article registration unit 21 causes the display device of the sales server 20 to display list information of sales packages received at step S104 in FIG. 8. Next, the administrator selects sales packages to be sold in the sales region to which the sales server 20 belongs, from among the sales packages in the list information. Furthermore, the administrator enters a license format, a license validity period, a volume number, and an article name for each sales package (step S112). Furthermore, according to need, the administrator defines a group and selects sales packages to belong to the group.

Next, the article registration unit 21 registers, in the article master 23, article information in which the configurations of articles relevant to the sales packages selected as sales packages to be sold are defined (step S113).

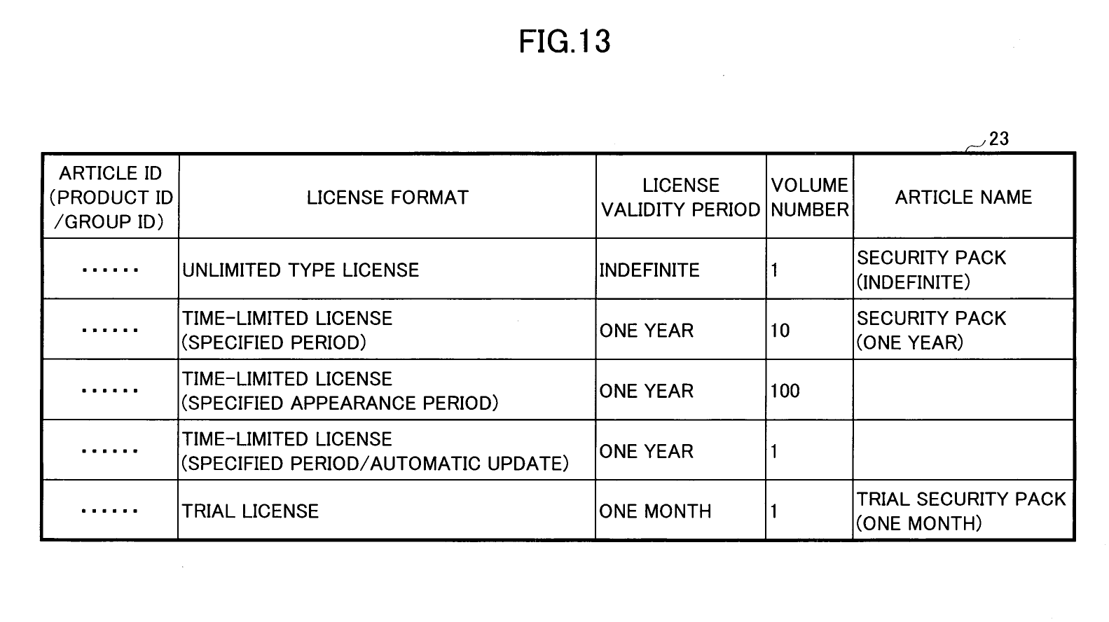

FIG. 13 illustrates an example of a configuration of the article master 23 in the sales server 20. As shown in FIG. 13, the article master 23 is a table for managing, for each article, an article ID (product ID or group ID), a license format, a license validity period, a volume number, and an article name. The license format is information indicating whether a license of a sales package belonging to an article is an unlimited type license, a time-limited license, or a trial license. An unlimited type license can be used indefinitely after purchase. A time-limited license is valid (usable) within a predetermined time period. A trial license is for trial usage. The license validity period is a valid attribute when the license format is a time-limited license or a trial license, which indicates the period during which the license is valid. The volume number indicates the volume number of the license. When an article having a volume number of two or more is purchased, a volume license is granted. Accordingly, the same sales package can be simultaneously used by a number of users within the volume number. The article name is the name of the article.

As article information is registered in the article master 23 of the sales server 20, the corresponding article can be sold in the sales region to which the sales server 20 belongs.

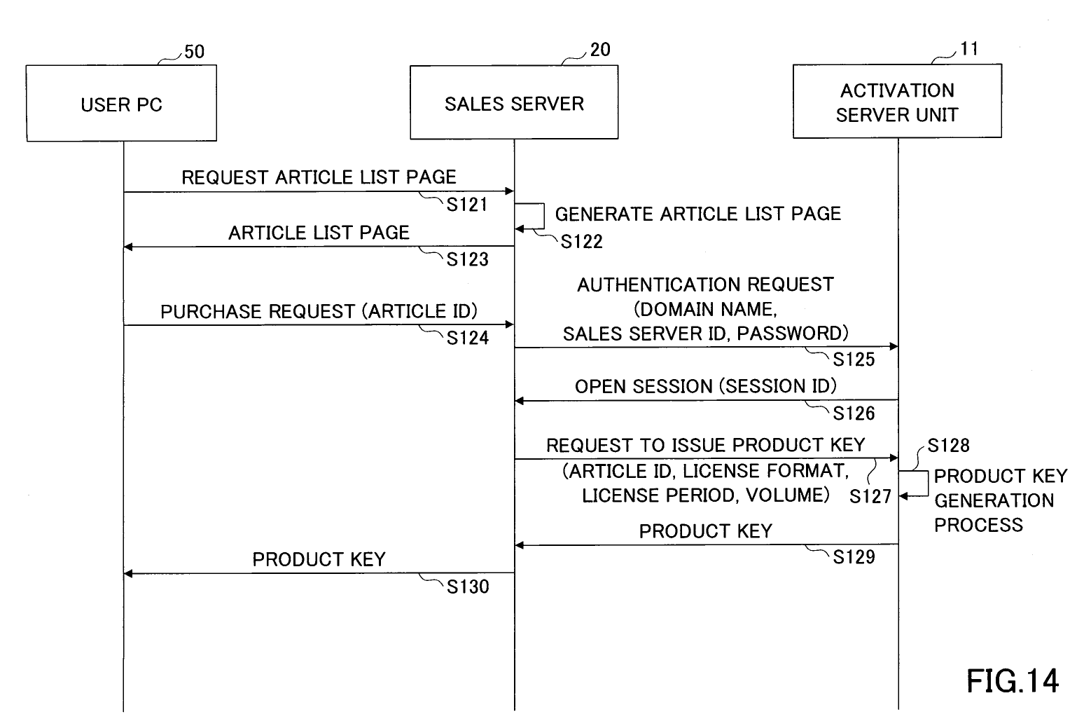

FIG. 14 is a sequence diagram for describing process procedures performed when an article is sold. The sales server 20 indicated in FIG. 14 belongs to the sales region to which the user PC 50 shown in FIG. 14 belongs.

When a user in a certain user environment E1 enters a URL of a web page (article list page) displaying a list of articles that can be purchased (that are sales objects), a web browser 51 sends a request to acquire an article list page to the sales management unit 22 of the sales server 20 (step S121).

Next, the sales management unit 22 generates an article list page based on the article master 23 (step S122). Specifically, the sales management unit 22 generates, as an article list page, HTML data for displaying an article name, a license format, a license validity period, a volume number, and a check button, for each article registered in the article master 23. A check button is used for selecting whether the article is to be a purchase object. Next, the sales management unit 22 returns the generated article list page to the web browser 51 (step S123). The web browser 51 causes the display device of the user PC 50 to display the received article list page.

In the article list page, when a user selects a check button corresponding to an article to be a purchase object and presses the purchase button, the web browser 51 sends, to the sales management unit 22, a purchase request including the article ID of the article selected as the purchase object (step S124). That is to say, the article list page is defined such that the selected article ID is sent as the purchase button is pressed. In the article list page, plural articles may be selected. Therefore, in step S124, the purchase request may include plural article IDs.

Next, the sales management unit 22 specifies a domain name, a sales site ID, and a password, and sends an authentication request to the activation server unit 11 of the license management server 10 (step S125). The sales server authentication unit 117 of the activation server unit 11 authenticates the sales server 20 by cross-checking the domain name, the sales site ID, and the password included in the authentication request with the domain name, the sales site ID, and the password included in the sales site master 118. When the authentication is successful, the sales server authentication unit 117 opens a session, and returns a session ID to the sales management unit 22 (step S126). Hereinafter, the communications between the sales management unit 22 and the activation server unit 11 are performed based on the session ID.

Next, the sales management unit 22 acquires, from the article master 23, the license format, the license validity period, and the volume number of the article ID (product ID or group ID) included in the purchase request. Then, the sales management unit 22 sends, to the product key issue unit 112 of the activation server unit 11, a request to issue a product key, by specifying the acquired license format, the license validity period, and the volume number of the corresponding article ID (product ID or group ID) (step S127).

In response to receiving the request to issue a product key, the product key issue unit 112 generates a product key (step S128). The product key issue unit 112 returns the generated product key to the sales management unit 22 (step S129). When a request is made to issue product keys for plural articles, one product key is generated for each of the articles.

When the product key is received, the product key report unit 24 of the sales server 20 returns HTML data including the received product key to the web browser 51 (step S130). The web browser 51 causes the display device of the user PC 50 to display the HTML data. Accordingly, the user can recognize the product key issued for the purchased article. The product key report unit 24 may distribute the product key by sending an e-mail describing the product key, to the user PC 50.

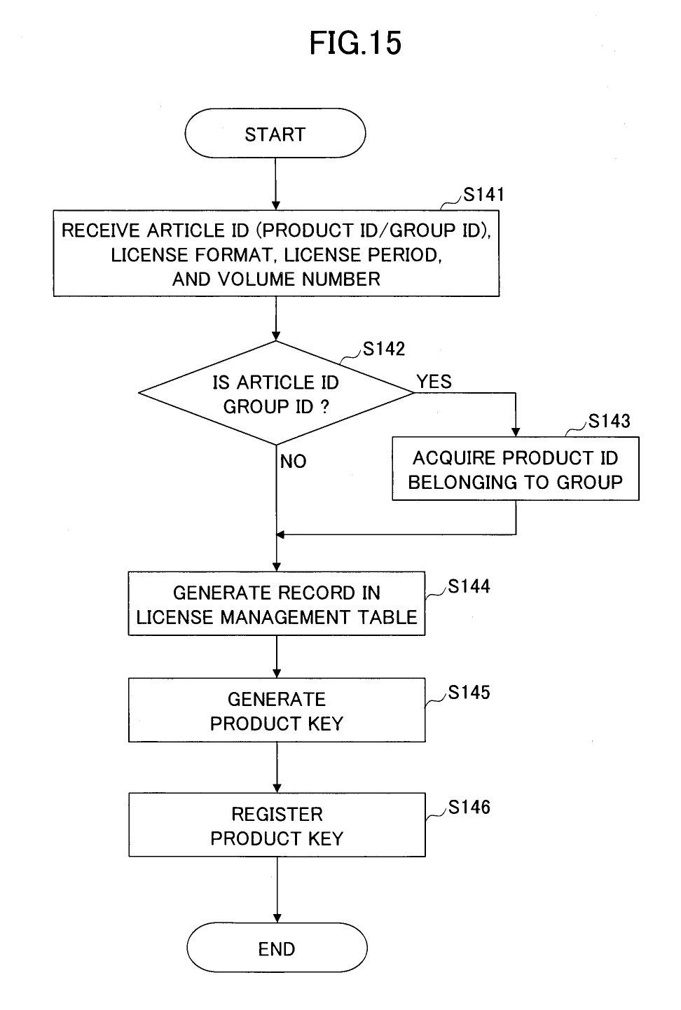

Next, a detailed description is given of step S128. FIG. 15 is a flow chart for describing process procedures of a product key generating process performed by the product key issue unit 112.

In step S141, the product key issue unit 112 receives the article ID (product ID or group ID), the license format, the license validity period, and the volume number. Next, the product key issue unit 112 determines whether the received article ID is a group ID (step S142). Specifically, the product key issue unit 112 searches for a group ID corresponding to the article ID from the group ID master 120. When a group ID corresponding to the article ID is found (YES in step S142), the product key issue unit 112 acquires, from the group ID master 120, all product IDs associated with the group ID (i.e., product IDs of sales packages belonging to the group) (step S143).

When the result of step S142 is NO, or after step S143, the product key issue unit 112 generates, in the license management table 121, a record for registering the received product ID or the product IDs acquired from the group ID master 120 (step S144). Thus, when plural product IDs are acquired from the group ID master 120, plural records are generated. Furthermore, the product key issue unit 112 generates a number of records corresponding to the volume number of the same product ID. Thus, when the volume number is two or more, two or more records are generated for the same product ID.

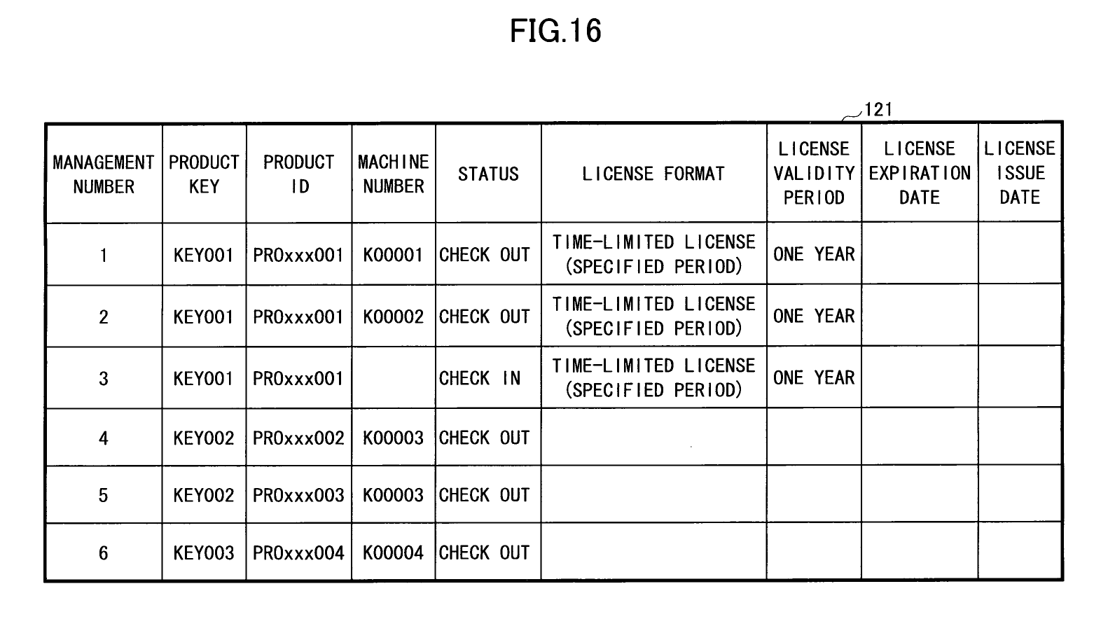

FIG. 16 illustrates an example of a configuration of the license management table 121. Items in the license management table 121 shown in FIG. 16 include a management number, a product key, a product ID, a machine number, a status, a license format, a license validity period, a license expiration date, and a license issue date, for each license issued for a sales package.

Among these items, as for the product ID, the license format, and the license validity period, values received from the sales management unit 22 are registered in step S144. When plural records are generated, the same value is registered in all of the generated records. However, in the case of a group license (when product IDs of sales packages are acquired based on a group ID), the acquired product IDs are respectively registered in the generated records.

The management number is an identifier (number) uniquely assigned to each record, as a record is generated in the license management table 121. A product key generated in a later step is registered in the product key field. A machine number of the image forming apparatus 40 specified as the device in which the sales package is to be used, is registered in the machine number field, when the license file 90 is issued. The machine number is identification information (device identifier) for uniquely identifying each image forming apparatus 40. The status is information indicating the status of the license. In the present embodiment, statuses of a license includes “no license”, “check out”, and “check”. “No license” is a status where a license is not issued. “Check out” is a status where a license is being used. “Check in” is a status where a license is released (usable). As for the status, a value is not registered in step S144. The license expiration date is the expiration date of the license (license file 90) calculated based on the license validity period, when the license file 90 is issued. The license issue date is the date when the license (license file 90) is issued, which is registered when the license file 90 is issued.

Next, the product key issue unit 112 generates one product key (step S145). Only one product key is generated, even when the article ID received in step S141 is a group ID, and even when the volume number is two or more.

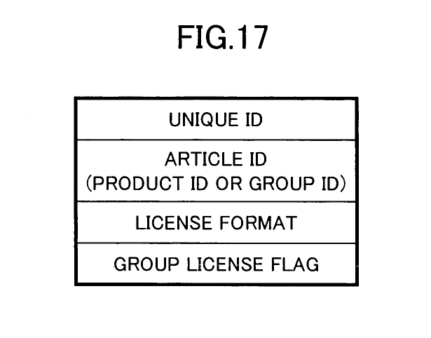

FIG. 17 illustrates an example of a configuration of a product key. As shown in FIG. 17, the product key is data including a unique ID, an article ID, a license format, and a group license flag.

The unique ID is an ID uniquely generated as the product key is generated. The uniqueness of the product key is established by the unique ID. The article ID is the product ID or group ID received in step S141; i.e., the product ID or group ID of the sales package or group corresponding to the purchased article. The license format is the license format received in step S141. The group license flag is a parameter indicating whether the article ID in the product key is a group ID (true) or not (false). The product key issue unit 112 sets the value of the group license flag as true, when the received article ID is a group ID.

Next, the product key issue unit 112 updates the license management table 121 by registering the generated product key in the record generated at step S144, and sets the status of the record as “check in” (step S146). When there are plural records generated in step S144 (when the license is a group license or when the volume number is two or more (volume license)), the same product key is registered in the plural records.

In the license management table 121 of FIG. 16, the records of management numbers 1 through 3 are records corresponding to a volume license. The records relevant to a volume license have same product key and the same product ID. The records of management numbers 4 and 5 are records corresponding to a group license (a license for a group). The records relevant to a group license have the same product key. However, the records of the group license correspond to different sales packages, and thus have different product IDs.

The product key generated as described above is sent to the sales management unit 22 of the sales server 20 in step S129 of FIG. 14, and is then transferred from the sales management unit 22 to the web browser 51 of the user PC 50.

Next, a sales package included in the article for which the product key is issued is installed.

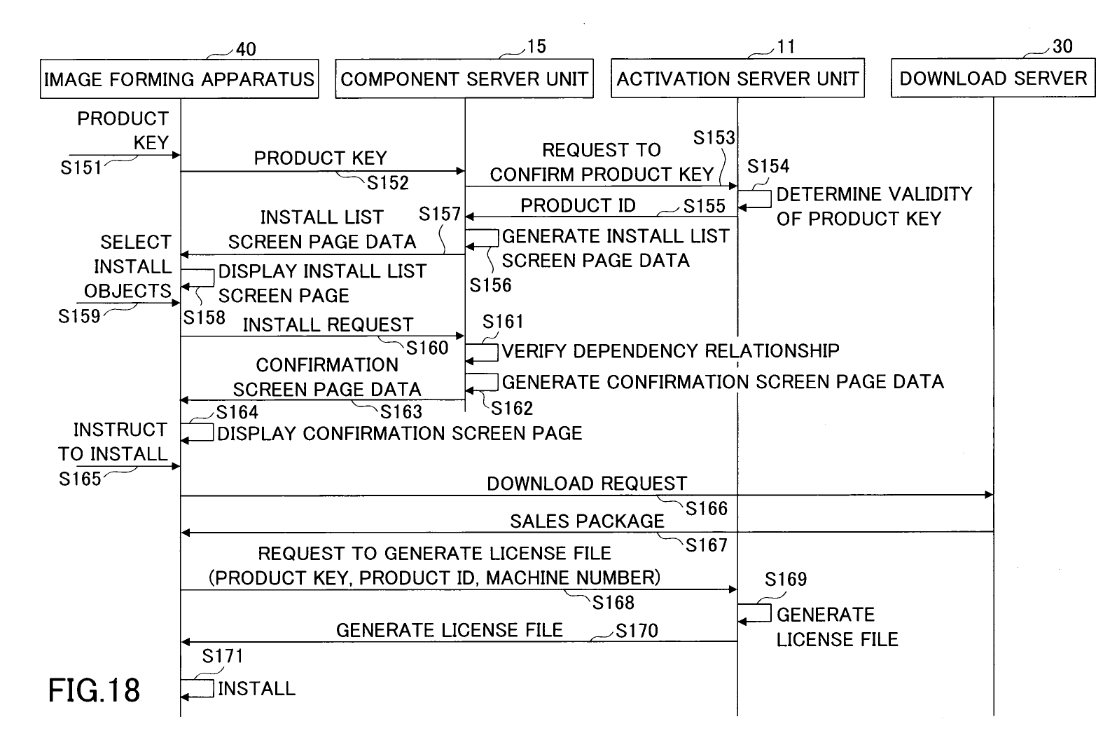

FIG. 18 is a sequence diagram for describing process procedures performed when installing a sales package.

A user who has acquired a product key enters the product key in the image forming apparatus 40 in which the sales package corresponding to the product key is to be used (step S151). The product key is entered via a function expansion setting menu screen page described below, which is displayed on the operations panel 45.

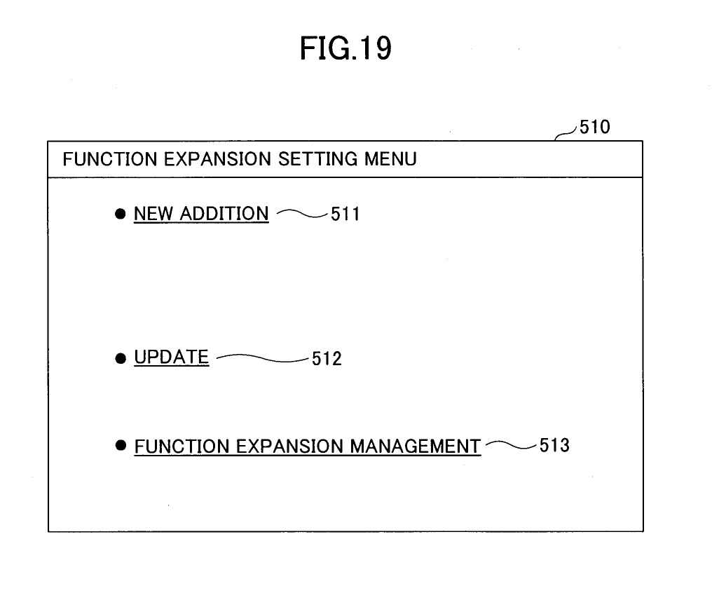

FIG. 19 illustrates a display example of a function expansion setting menu screen page. A function expansion setting menu screen page 510 is for displaying various menus relevant to expanding functions of the image forming apparatus 40. When a predetermined operation is entered, the UI control unit 426 causes the operations panel 45 to display the function expansion setting menu screen page 510. In the function expansion setting menu screen page 510, when a new addition menu 511 is selected, the UI control unit 426 causes the operations panel 45 to display a product key enter screen page.

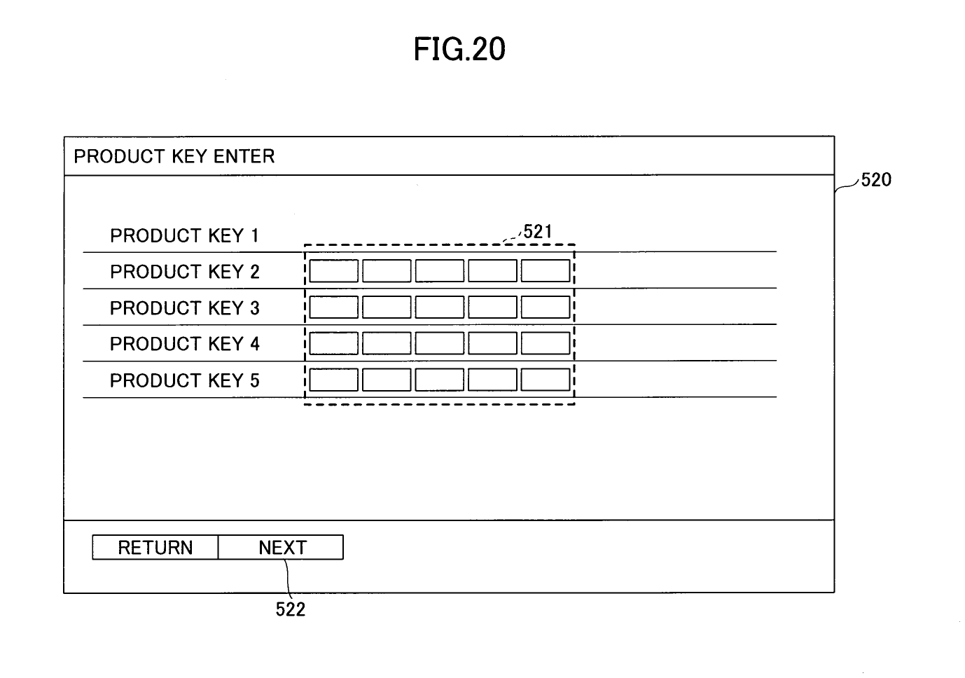

FIG. 20 illustrates a display example of a product key enter screen page. A product key enter screen page 520 includes a product key enter field 521. In step S151, the product key is entered in the product key enter field 521.

When the product key is entered in the product key enter field 521, and a next button 522 is pressed, the install unit 421 specifies the entered product key and sends a request to generate an install list screen page relevant to the sales package corresponding to the product key, to the install support unit 152 of the component server unit (step S152).

Next, when the request to generate an install list screen page is received, the install support unit 152 sends a request to confirm the validity of the product key specified in the request, to the product key validation unit 113 of the activation server unit 11 (step S153). The product key validation unit 113 refers to the license management table 121, and determines the validity of the product key (step S154). Specifically, it is determined that the product key is valid when a record including the product key is registered, the status of the record including the product key is not “check out”, and when the present date is not past the license expiration date of the record including the product key (including a case where the license expiration date is not registered). Otherwise, it is determined that the product key is invalid. When the product key is valid, the product key validation unit 113 returns, to the install support unit 152, a product ID associated to the product key in the license management table 121 (i.e., the product ID of the sales package) (step S155). Thus, plural product IDs are returned in the case of a group license or a product key relevant to a volume license.

Meanwhile, when the target product key is determined to be invalid, the install support unit 152 returns, to the install unit 421, error screen page data for displaying an error screen page indicating that the product key is invalid. In response to receiving the error screen page data, the install unit 421 causes the UI control unit 426 to display the error screen page based on the error screen page data.

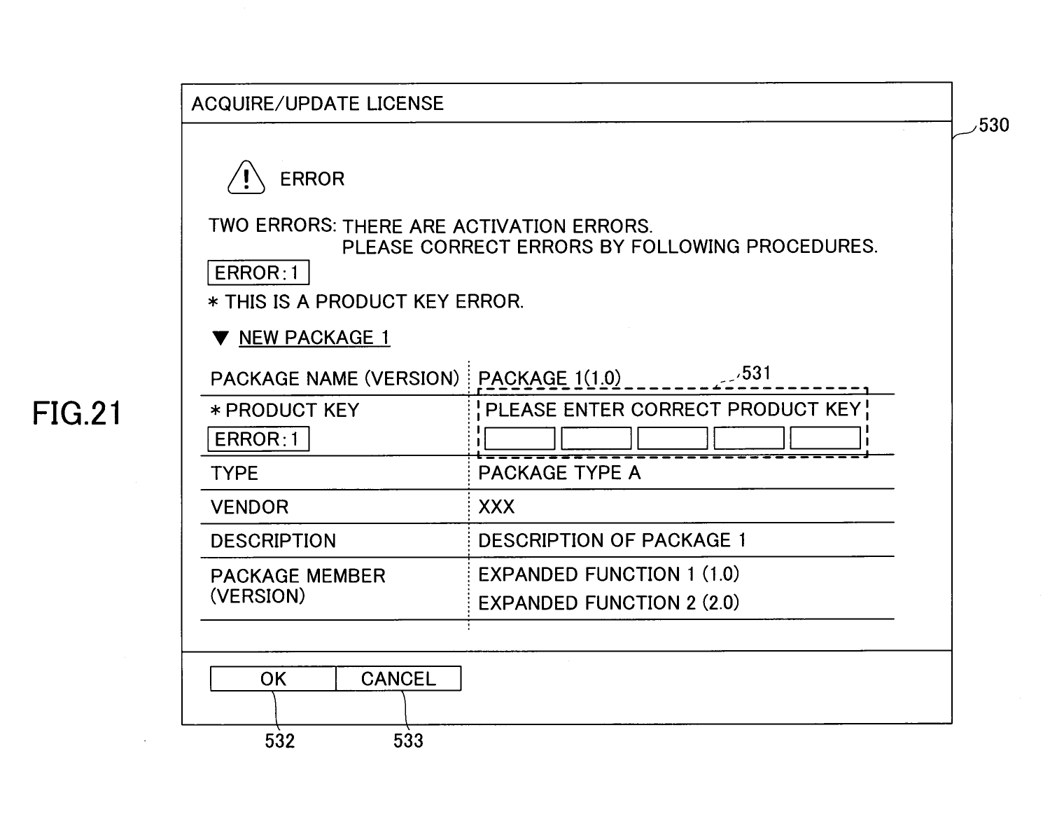

FIG. 21 illustrates a display example of an error screen page when the product key is invalid. An error screen page 530 displays a message indicating that a product key error (that the product key is invalid) and a product key enter field 531. The user can re-enter the correct product key in the product key enter field 531. When the correct product key is entered in the product key enter field 531, and an OK button 532 is selected, the steps from step S152 onward are executed once again. Meanwhile, when a cancel button 533 is selected, the operation of installing the sales package is aborted.

In step S155, when a determination result indicates that the product key is determined to be valid, the install support unit 152 generates install list screen page data relevant to a sales package corresponding to the product ID returned from the product key validation unit 113, by referring to the component management table 155 (step S156).

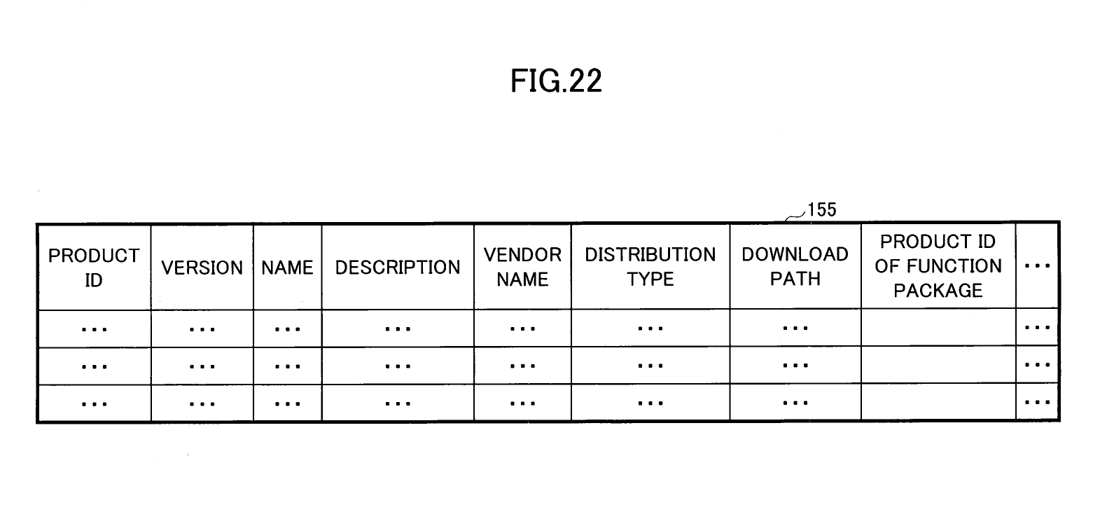

FIG. 22 illustrates an example of a configuration of the component management table 155. As shown in FIG. 22, the component management table 155 has a product ID, a version, a name, a description, a vendor name, a distribution type, a download path, and a product ID of a function package, recorded for each sales package. The version is the version of the sales package. The name is the name of the sales package. The description is for describing the sales package. The vendor name is the name of the vendor of the sales package. The distribution type is the distribution type of the sales package. The download path is the position information of the sales package in the sales package management unit 32 in the download server 30. In the present embodiment, a URL (Uniform Resource Locator) is used as the position information. The product ID of the function package is a list of product IDs of function packages belonging to the sales package.

The contents of the component management table 155 are registered as the component management unit 154 periodically acquires sales packages from the download server 30 and analyzes the acquired sales packages. Specifically, the product ID, the version, the name, the description, the vendor name, and the distribution type recorded in the sales package information file stored in the sales package, are registered. As the product ID of the function package, the product ID recorded in the function package information file stored in each function package included in the sales package, is registered. The download path is reported from the download server 30 when acquiring a sales package.

Next, the install support unit 152 sends the generated install list screen page data to the install unit 421 of the image forming apparatus 40 (step S157). The install unit 421 enters the received install list screen page data in the UI control unit 426. The UI control unit 426 causes the operations panel 45 to display an install list screen page based on the install list screen page data (step S158).

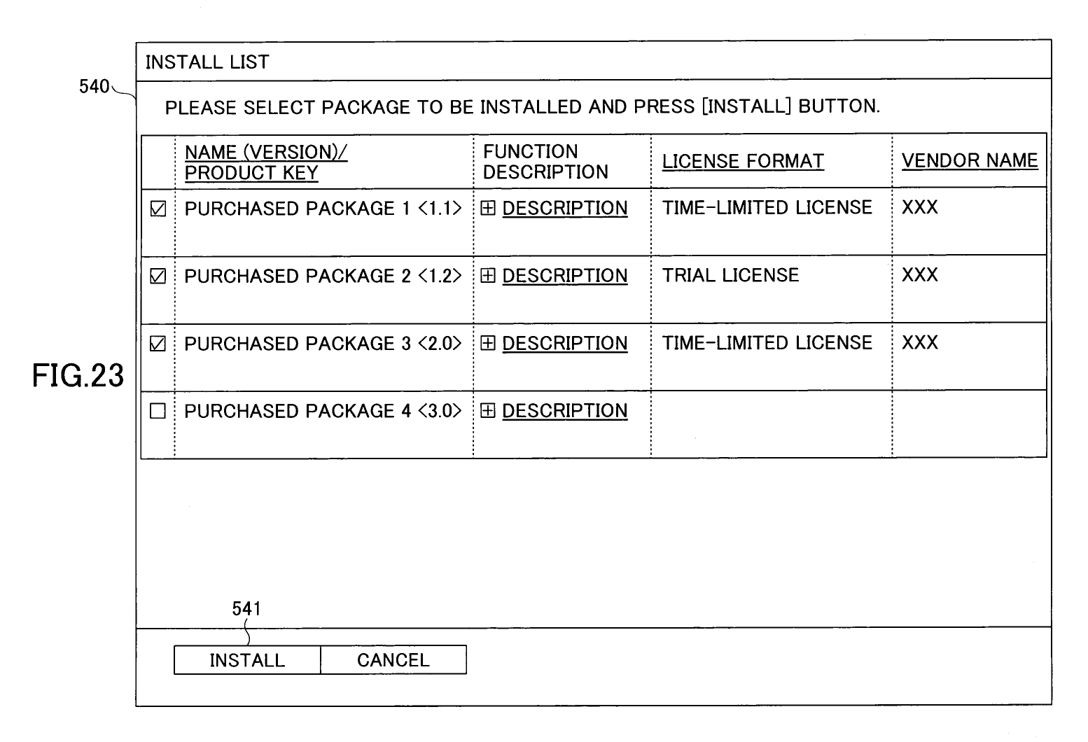

FIG. 23 illustrates a display example of an install list screen page. In an install list screen page 540, a list of sales packages that may be install objects (install candidates) is displayed. A check button is provided for each sales package, which is used for selecting whether to install the corresponding sales package. A user ticks the check button of the sales package to be the install object. In FIG. 23, packages 1 through 4 are install candidates, and packages 1 to 3 are selected as install objects.

In the install list screen page 540, when the check buttons of the sales packages to be install objects are ticked and an install button 541 is selected (step S159), the install unit 421 specifies the product IDs of the sales packages ticked in the install list screen page 540 (selected as install objects) and configuration information of all sales packages installed in the image forming apparatus 40, and sends, to the install support unit 152 of the component server unit 15, a request to install the sales packages selected as install objects (step S160).

The product IDs of the sales packages checked in the install list screen page 540 are acquired from the install list screen page data. Furthermore, the configuration information of all sales packages installed in the image forming apparatus 40 is acquired from the install information management table 427.

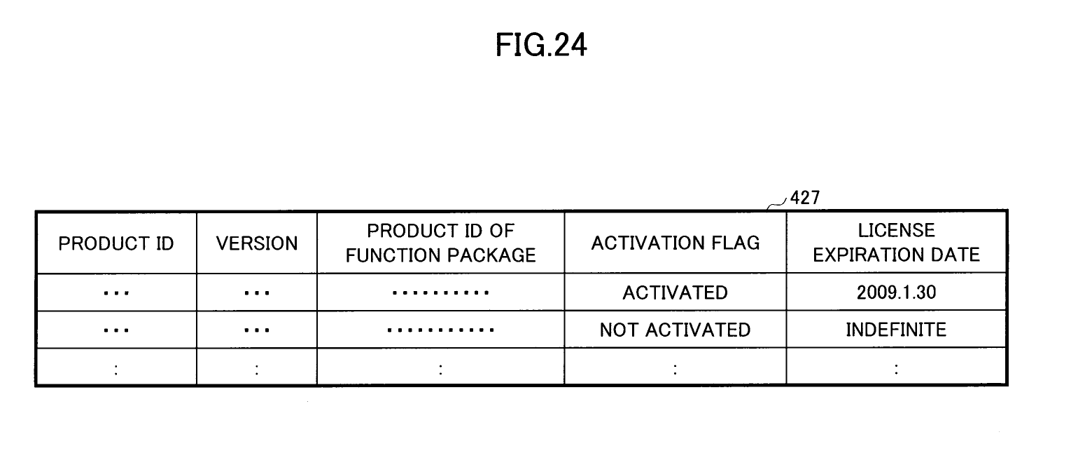

FIG. 24 illustrates an example of a configuration of the install information management table 427. As shown in FIG. 24, the install information management table 427 has a product ID, a version, a product ID of a function package, an activation flag, and a license expiration date recorded for each sales package installed in the image forming apparatus 40.

The product ID of the function package is a list of product IDs of function packages belonging to the sales package. The activation flag indicates whether the sales package is activated or not (already activated or not). The license expiration date is the expiration date of the license issued for the sales package (expiration date of the license file 90). The activation flag and license expiration date of each function package are in accordance with the activation flag and the license expiration date of the sales package to which the corresponding function package belongs. Furthermore, contents of the install information management table 427 are registered when installing the sales package as described below.

The configuration information that is sent in step S160 includes all information registered in the install information management table 427.

Next, the install support unit 152 causes the dependency relationship determining unit 151 to verify the dependency relationship of the sales package relevant to the product ID included in the install request (step S161). Specifically, the dependency relationship determining unit 151 determines whether another function package, which is depended upon (used) by the function package included in the sales package relevant to the product ID, is already installed in the image forming apparatus 40. That is to say, the dependency relationship determining unit 151 determines whether it is possible to install the sales package relevant to the product ID.

Next, the install support unit 152 generates HTML data (confirmation screen page data) for displaying a confirmation screen page according to the verification result of the dependency relationship (step S162), and returns the confirmation screen page data as an example of install possibility information to the install unit 421 (step S163). Details of steps S162 and S163 are described below.

Next, the install unit 421 enters the received confirmation screen page data in the UI control unit 426. The UI control unit 426 causes the operations panel 45 to display a confirmation screen page based on the confirmation screen page data (step S164).

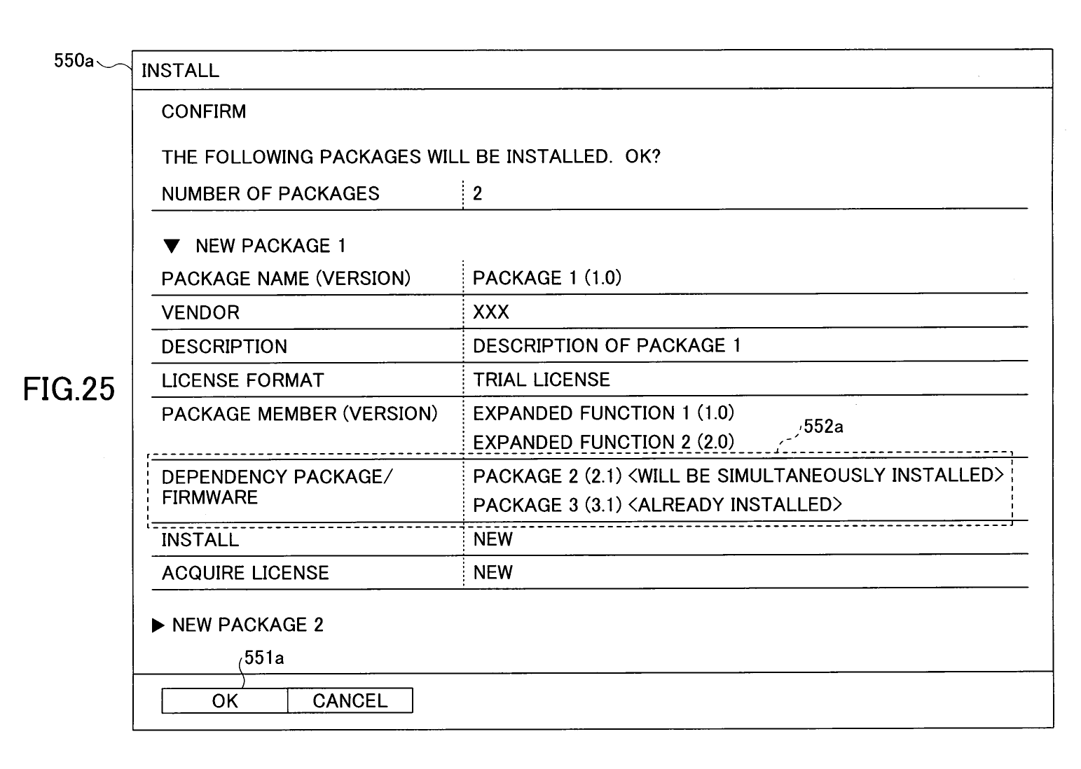

FIG. 25 illustrates a display example of a confirmation screen page when there is no problem with the dependency relationship. A confirmation screen page 550a shown in FIG. 25 indicates that there is no problem with the dependency relationship for the sales package (package 1) selected as an install object. Specifically, a region 552a indicates that a sales package (dependency package) on which the package 1 depends is simultaneously selected as an install object or is already installed in the image forming apparatus 40.

When an OK button 551a is selected in the confirmation screen page 550a (step S165), the install unit 421 specifies URLs for the sales packages selected as install objects, and sends a request to download the sales packages to a download process unit 31 of the download server 30 (step S166). That is to say, the OK button 551a is associated with the URLs of the sales packages and the instruction to send a download request.

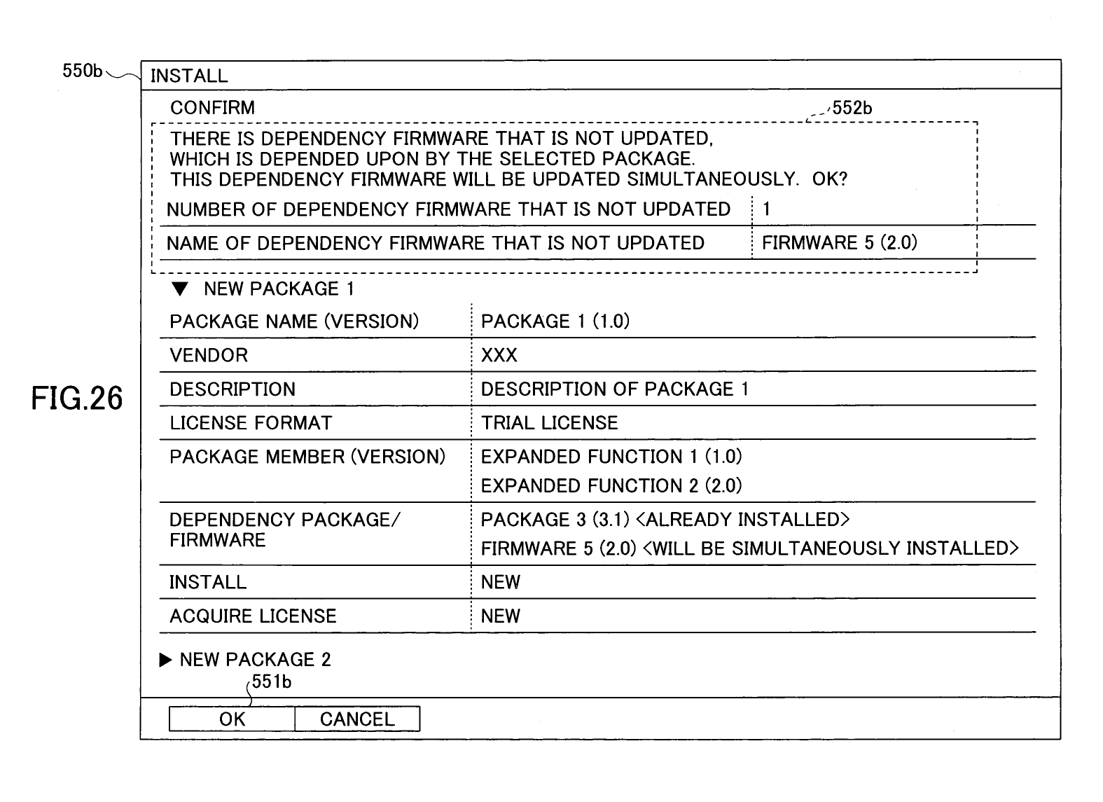

FIG. 26 illustrates a display example of a confirmation screen page when a dependency package can be simultaneously installed (with a sales package). A region 552b of a confirmation screen page 550b shown in FIG. 26 indicates that among the dependency packages of the sale packages selected as install objects, there is a dependency package that is not installed in the image forming apparatus 40 or not selected as an install object. Furthermore, the region 552b indicates that such a dependency package can be simultaneously installed, and inquires whether to simultaneously install the dependency package. It is determined whether a dependency package can be simultaneously installed based on the distribution type of the dependency package.

When an OK button 551b is selected in the confirmation screen page 550b (step S165), the install unit 421 specifies URLs of sales packages selected as install objects and sales packages (dependency packages) to be simultaneously installed, and sends a request to download the sales packages to the download process unit 31 of the download server (step S166). The OK button 551b is associated with the URLs of the sales packages selected as install objects, the URLs of the sales packages (dependency packages) to be simultaneously installed, and an instruction to send a download request.

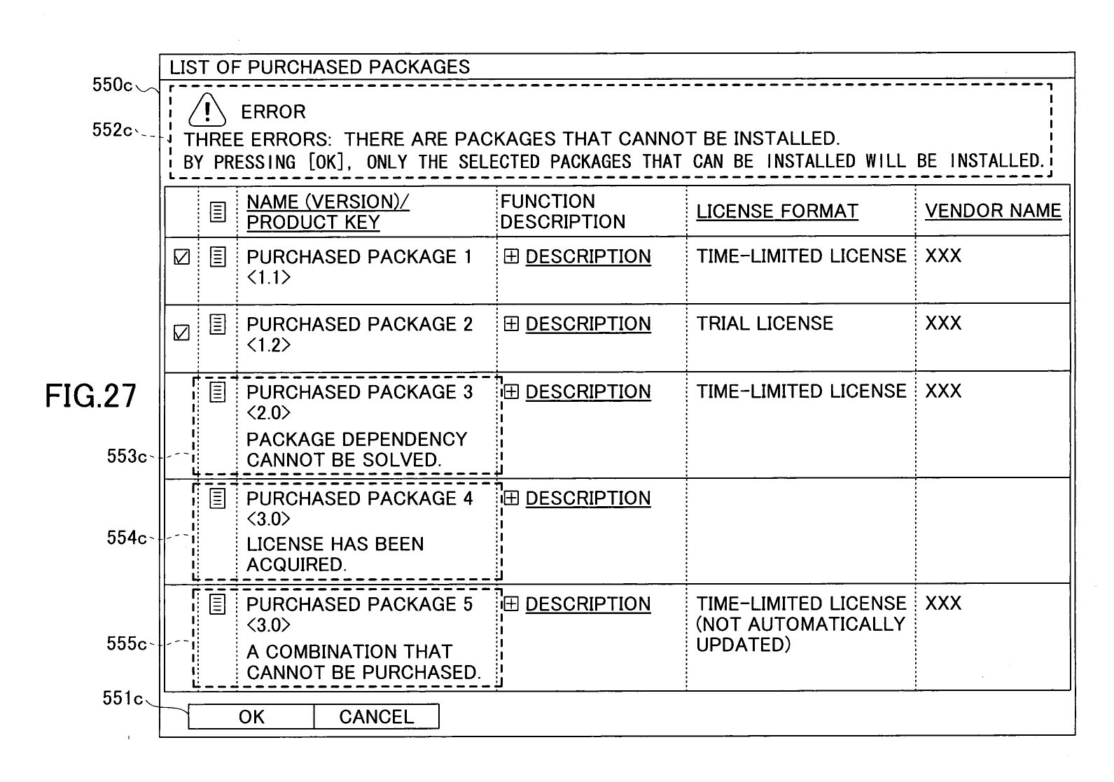

FIG. 27 illustrates a display example of a confirmation screen page when a dependency package cannot be simultaneously installed (with a sales package). A region 552c of a confirmation screen page 550c shown in FIG. 27 indicates that there are three sales packages that cannot be installed. Details of these three sales packages are indicated in regions 553c, 554c, and 555c. The region 553c indicates that the dependency relationship cannot be satisfied for package 3 (the dependency package cannot be simultaneously installed). The region 554c indicates that the license is already acquired (used) for package 4. The region 555c indicates that package 5 cannot be simultaneously installed with other packages (package 1 and package 2 in FIG. 27) that are selected as install objects. FIG. 27 illustrates a case where packages 1 through 5 are selected as install objects.

When an OK button 551c is selected in the confirmation screen page 550c (step S165), the install unit 421 specifies URLs of sales packages that can be installed, and sends a request to download the sales packages to the download process unit 31 of the download server 30 (step S166). The OK button 551c is associated with the URLs of the sales packages that can be installed, and an instruction to send a download request.

In response to receiving the download request of step S166, the download process unit 31 acquires, from the sales package management unit 32, the sales packages identified by the URLs specified in the download request, and transfers the acquired sales packages to the install unit 421 (step S167). The install unit 421 saves the received sales packages in a temporary storage area (for example, a temporary folder), in the HDD 414.

When the operation of downloading the sales packages is completed, the install unit 421 specifies the product key entered in step S151, the product IDs of the sales packages selected as install objects, and the machine number of the image forming apparatus 40 recorded in the ROM 413 or the HDD 414, and sends a request to generate the license file 90 (a request to use the license) to the license issue unit 115 of the activation server unit 11 (step S168). Next, the license issue unit 115 generates the license file 90 based on the product key and the license management table 121 (step S169).

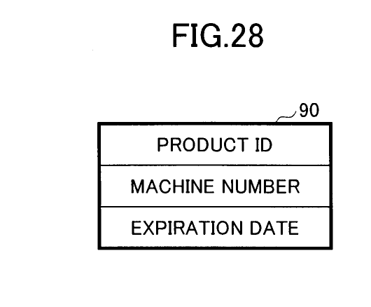

FIG. 28 illustrates an example of a configuration of the license file 90. The license file 90 includes a product ID, a machine number, and an expiration date. The product ID is the product ID of the sales packages to which a license is given (allowed to be used) by the license file 90. The machine number is the machine number of the image forming apparatus 40 that is allowed to use the sales package relevant to the product ID by the license file 90. The expiration date is the expiration date of the license file 90, i.e., the expiration date of the license given by the license file 90.

The product ID relevant to the product key included in the request to generate the license file 90 is registered as the product ID in the license file 90. When the product key is relevant to a group license, i.e., when plural different product IDs are registered in the license management table 121 for the product key, the license issue unit 115 generates a license file 90 for each sales package. Accordingly, even in the case of a group license, the product ID of a sales package is registered as the product ID in the license file 90.

The machine number included in the request to generate the license file 90 is registered as the machine number of the license file 90. As the expiration date of the license file 90, a date (for example, year/month/day) obtained by adding the validity period registered in the license management table 121 for the product key and product ID included in the request to generate the license file 90 to the present date, is registered.

Next, the license issue unit 115 returns the generated license file 90 to the install unit 421 (step S170). The install unit 421 saves the received license file 90 in a temporary storage area (for example, a temporary folder), in the HDD 414.

When the operation of receiving the license file 90 is completed, the install unit 421 performs the process of installing the sales package (step S171). Details of the install process are described below.

In the above example, the instruction to acquire a sales package is sent to the image forming apparatus 40 based on the install list screen page data of step S157 or the confirmation screen page data of step S163. However, in another example, the sales package itself (program entity) may be sent to the image forming apparatus 40 at this timing. In this case, the component server unit 15 downloads the sales package that is the install object from the download server 30, and transfers the sales package to the image forming apparatus 40.

Next, details of the process executed by the component server unit 15 of the license management server 10 at steps S161 and S162 of FIG. 18 are described.

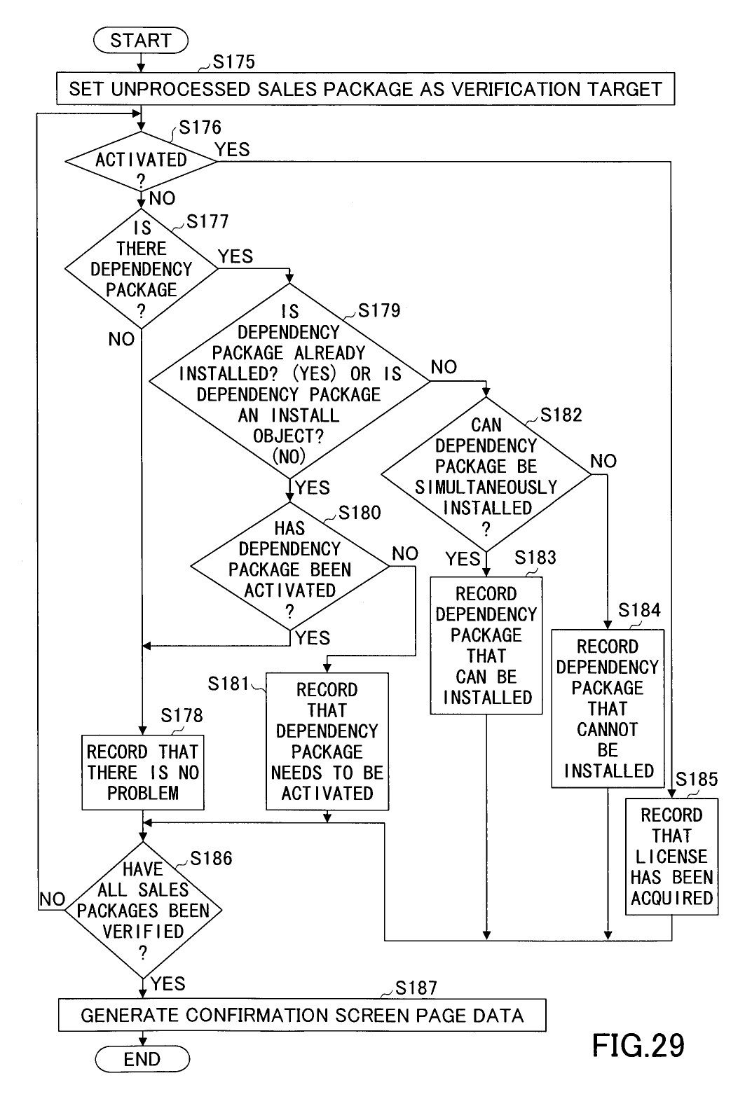

FIG. 29 is a flowchart for describing process procedures of a process of verifying the dependency relationship and a process of generating confirmation screen page data, performed by the component server unit 15.

In step S175, the dependency relationship determining unit 151 sets, as the process target, one product ID (i.e., a sales package) among the product IDs received in the verification request for the dependency relationship at step S160 of FIG. 18. Next, the dependency relationship determining unit 151 determines whether the sales package that is the process target (hereinafter, “current sales package”) is already activated, based on the activation flag included in configuration information for the current sales package, included among the configuration information received for the sales packages in step S160 (step S176). When the current sales package is not activated (NO in step S176), the dependency relationship determining unit 151 determines whether there is a sales package (dependency package that is depended upon by the current sales package, based on the component management table 155 (see FIG. 22) and the dependency relationship management table 156 (step S177).

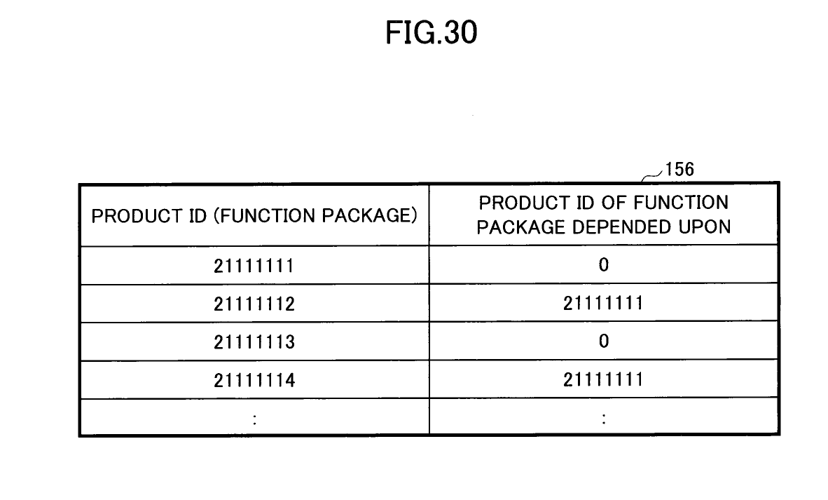

FIG. 30 illustrates an example of a configuration of the dependency relationship management table 156. As shown in FIG. 30, the dependency relationship management table 156 has a product ID of a function package and a product ID of another function package depended upon by the function package, registered for each function package. Plural product IDs of function packages that are depended upon may be registered. In FIG. 30, “0” indicates that there are no function packages that are depended upon by the corresponding function package.

Contents of the dependency relationship management table 156 are registered as the component management unit 154 analyzes contents of sales packages that are periodically acquired, similar to the case of the component management table 155. Specifically, contents of the package dependency information recorded in the function package information files of the function packages included in the sales package, are registered in the dependency relationship management table 156 as product IDs of the function packages that are depended upon.

In step S177, the dependency relationship determining unit 151 acquires a list of product IDs of function packages registered for the product ID of the current sales package in the component management table 155. Next, the dependency relationship determining unit 151 identifies a function package depended upon by the function package (hereinafter, “dependency function package”), based on the acquired product IDs of function packages and the dependency relationship management table 156. When there is a dependency function package, the dependency relationship determining unit 151 identifies the sales package to which the corresponding dependency function package belongs, by reverse looking up the component management table 155. The identified sales package is the dependency package of the current sales package. There may be plural dependency packages. Furthermore, the operation of searching the dependency relationship between function packages may be performed recursively.

When there are no dependency packages (NO in step S177), the dependency relationship determining unit 151 records an indication that there is no problem in the dependency relationship of the current sales package, in the memory device 103 in association with the product ID of the current sales package (step S178). When there is a dependency package (YES in step S177), the dependency relationship determining unit 151 determines whether the dependency package is already installed in the image forming apparatus 40, or whether the dependency package is an install object, based on the configuration information received for the sales packages in step S160, or the product IDs of the sales packages that are an install objects received at step S160 (step S179). That is to say, if configuration information corresponding to the dependency package is received, the dependency package is determined to be already installed in the image forming apparatus 40. Furthermore, if the product ID of the dependency package is included in the product IDs of install objects, the dependency package is determined to be an install object.

When the dependency package is already installed (YES in step S179), the dependency relationship determining unit 151 determines whether the dependency package is already activated (i.e., already in a usable state) for each sales package, based on the received configuration information (step S180). Specifically, the dependency relationship determining unit 151 determines whether the dependency package is activated based on the activation flag included in the configuration information corresponding to the dependency package.

When the dependency package is already activated, or when the dependency package is an install object (YES in step S180), the dependency relationship determining unit 151 records, in the memory device 103, an indication that there is no problem in the dependency relationship of the current sales package in association with the product ID of the current sales package (step S178). When there is a dependency package that is not activated (NO in step S180), the dependency relationship determining unit 151 records an indication that the corresponding dependency package needs to activated for the current sales package, in association with the product ID of the current sales package (step S181).

Furthermore, when there is a dependency package that is not installed (NO in step S179), the dependency relationship determining unit 151 determines whether the dependency package can be simultaneously installed, based on the component management table 155 (step S182). Specifically, when the distribution type corresponding to the product ID of the dependency package indicates that activation is unnecessary in the component management table 155, the dependency relationship determining unit 151 determines that the dependency package can be simultaneously installed. When the distribution type of the dependency package indicates that activation is necessary, the dependency relationship determining unit 151 determines that the dependency package cannot be simultaneously installed.

When there is a dependency package that can be simultaneously installed (YES in step S182), the dependency relationship determining unit 151 records, in the memory device 103, the product ID of the dependency package as the product ID of a dependency package that can be simultaneously installed in association with the product ID of the current sales package (step S183). When there is a dependency package that cannot be simultaneously installed (NO in step S182), the dependency relationship determining unit 151 records, in the memory device 103, the product ID of the dependency package as the product ID of a dependency package that cannot be simultaneously installed in association with the product ID of the current sales package (step S184).

When the current sales package is already activated (YES in step S176), the dependency relationship determining unit 151 records, in the memory device 103, an indication that the license has been acquired in association with the product ID of the current sales package (step S185).

When the processes of steps S175 through S185 are completed for all of the product IDs received in the request to verify the dependency relationship in step S161 of FIG. 18 (YES in step S186), the install support unit 152 generates confirmation screen page data based on information recorded in the memory device 103 (step S187). For example, when there is no problem with all of the sale packages, confirmation screen page data for displaying the confirmation screen page 550a of FIG. 25 is generated. Furthermore, when information relevant to step S183 is recorded, confirmation screen page data for displaying the confirmation screen page 550b of FIG. 26 is generated. Furthermore, when information relevant to step S181, step S184, or step S185 is recorded, confirmation screen page data for displaying the confirmation screen page 550c of FIG. 27 is generated.

In the confirmation screen page data, the URL of a sales package that can be installed is associated to the OK button. The URL of the sales package that can be installed is acquired from a download path of the component management table 155.

In the above description, dependency packages are indicated in units of sales packages. However, dependency packages may be indicated in units of function packages. Even if dependency packages are indicated in units of function packages, in the present embodiment, products are distributed in units of sales packages, and therefore a sales package including the function packages is selected as an install object.

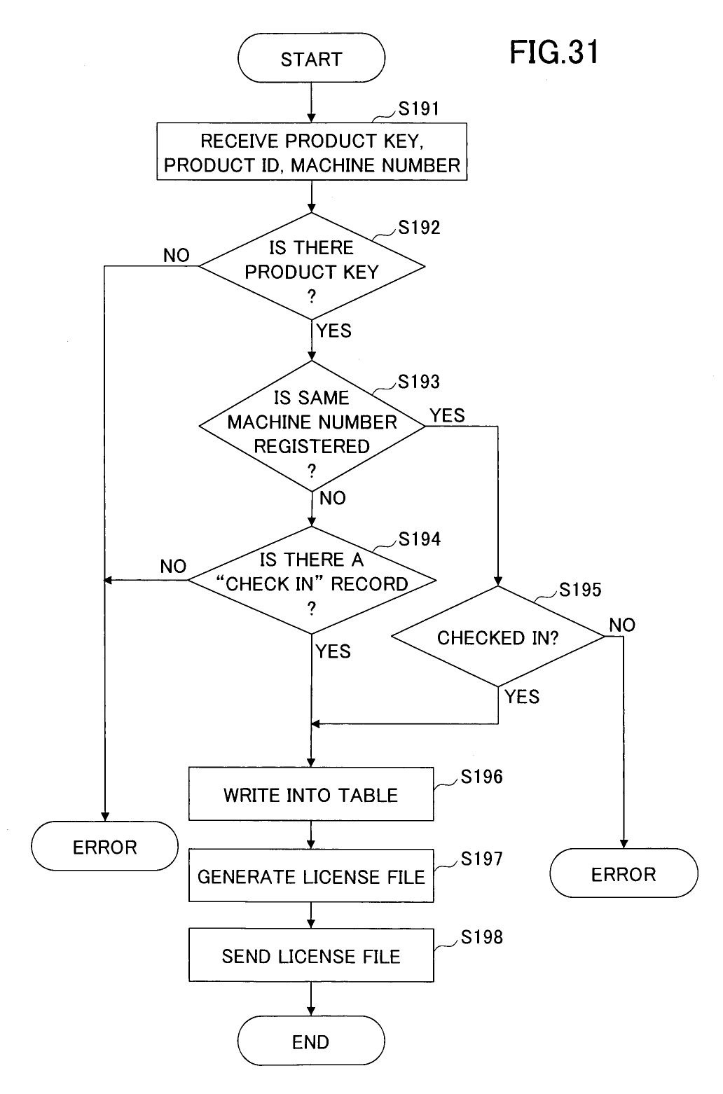

Next, a description is given of details of the process executed by the activation server unit 11 of the license management server 10, in steps S168 through S170 in FIG. 18. FIG. 31 is a flowchart for describing processing procedures of a license file generation process performed by the activation server unit 11. In the process for FIG. 31, a single product key is described as the process target. Therefore, when plural product keys are received, step S192 and onward are repeatedly performed for all product keys.

In step S191, the dependency relationship determining unit 151 receives a request to use the license including the product key, the product TO and the machine number, from the install unit 421 of the image forming apparatus 40. Next, the license issue unit 115 determines whether to allow usage of the license relevant to the product key. Specifically, the license issue unit 115 confirms whether the received product key is registered in the license management table 121 (step S192). When the product key is registered (YES in step S192), the license issue unit 115 confirms whether the same machine number as the received machine number is registered in the license management table 121 for the corresponding product key (step S193). When the same machine number is not registered (NO in step S193), the license issue unit 115 confirms whether there is a record whose status is “check in” is included in the license management table 121, among the records relevant to the corresponding product key and the received product ID (step S194). When such a record is included (YES in step S194), the dependency relationship determining unit 151 records the received machine number in the record, and changes the status of the record to “check out” (step S196). Specifically, it is recorded that the license corresponding to the product key is used. Furthermore, when a license validity period is recorded in the record (that is to say, when the record corresponds to a time-limited license), the license issue unit 115 records a date obtained by adding the license validity period to the present date in the record, as a license expiration date.

Next, the license issue unit 115 generates a license file 90 (see FIG. 28) including the product ID, the machine number, and the license expiration date in the record (step S197). A license file 90 is generated for each record of the license management table 121, i.e., for each license of the sales package. Next, the license issue unit 115 returns the generated license file 90 to the install unit 421 of the image forming apparatus 40 (step S198).

Meanwhile, when there is a record in which the same machine number as the machine number received for the product key is registered (YES in step S193), the license issue unit 115 confirms whether the status of the record is “check in” (step S195). When the status is “check in” (YES in step S195), the processes of step S196 onward are executed.

When a record relevant to the product key is not registered in the license management table 121 (NO in step S192), or when there is no record whose status is “check in” included in the license management table 121 among the records relevant to the corresponding product key and the received product ID (NO in step S194), or when there is a record in which the same machine number as the machine number received for the product key is registered and the status of the record is not “check in” (NO in step S195), the license issue unit 115 determines that an error has been detected, and does not generate the license file 90, i.e., a license is not issued.

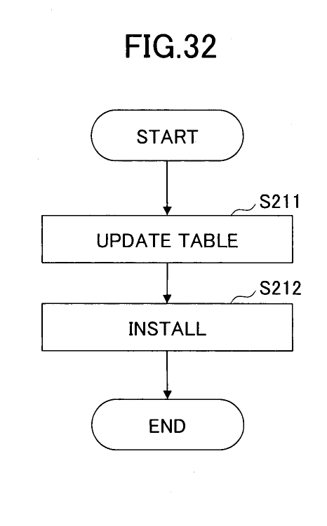

Next, a detailed description is given of the process executed by the image forming apparatus 40 in step S171 of FIG. 18. FIG. 32 is a flowchart for describing process procedures of a process of installing a sales package performed by the image forming apparatus 40.

In step S211, the install unit 421 registers, in the install information management table 427, information included in the sales packages saved in a temporary storage area and information included in the license files 90. That is to say, the product IDs and versions recorded in the sales package files included in the sales packages are registered as the product IDs and versions in the install information management table 427. The product IDs recorded in function package information files stored in function packages included in the sales packages are registered as the product IDs of function packages. Values indicating that the sales packages are activated are recorded as the activation flags. The expiration dates recorded in the license files 90 are recorded as the license expiration dates.

Next, the install unit 421 saves, in a predetermined storage location (folder), the license files 90 and sales packages which are saved in a temporary storage area, so that the corresponding sales packages can be used.

The license file 90 is used for the license check executed by the license check unit 424, when the function package included in the sales package is used. That is to say, the license check unit 424 allows the function package to be activated, only when there is a license file 90 corresponding to the sales package to which the function package that is selected as an activation object belongs, when the machine number in the license file 90 is the same as the machine number of the image forming apparatus 40 in which the function package is to be activated, and when the expiration date of the license file 90 has not passed. Otherwise, activation of the function package is not allowed. However, the license check of the license check unit 424 may be performed based on the component management table 155.

A fee is charged for installing the sales package, based on information in the license management table 121 periodically acquired by the activation server unit 11. More specifically, when the license management table 121 includes a record indicating that the license issue date is later than the last time a fee was charged, a fee is charged for the license relevant to such a record.

As described above, according to the first embodiment, the user inputs operations according to screen pages that are sequentially displayed on the image forming apparatus 40 by being guided by the activation server unit 11 or the component server unit 15 of the license management server 10. Accordingly, the user can easily instruct a series of operations including downloading a sales package, activating the sales package, and installing the sales package.

Furthermore, the dependency relationship of a sales package selected as an install object is automatically verified, and the dependency package is automatically included as the install object. Therefore, the user can feel safe to install a sales package without worrying about the complex dependency relationships between sales packages.

Furthermore, the vendor of the articles (manufacturer environment E2) can appropriately manage the status of sales packages used by customers. Specifically, by referring to the license management table 121, the vendor can recognize (manage) the types of sales packages are being used based on the types of licenses in units of image forming apparatuses 40 (machine numbers). For example, when a bug is detected in a sales package or when a sales package has been upgraded, the vendor can identify the image forming apparatus using the corresponding sales package, and can provide appropriate after-the-sale services.

Furthermore, the expiration date of the license is not determined when the article is purchased (when a purchase application is submitted to the sales server 20), but the expiration date is determined when the sales package is installed (i.e., when starting to use the license starts). Accordingly, licenses can be handled with flexibility. Specifically, after purchasing an article, a user can install a sales package at any convenient time, without loosing any time from the license validity period.

Next, a description is given of a license update process. When the license of an article is a time-limited license and the article relevant to the time-limited license is to be continuously used after the time limit, the user can extend the validity period of the license of the article by executing a license update process.

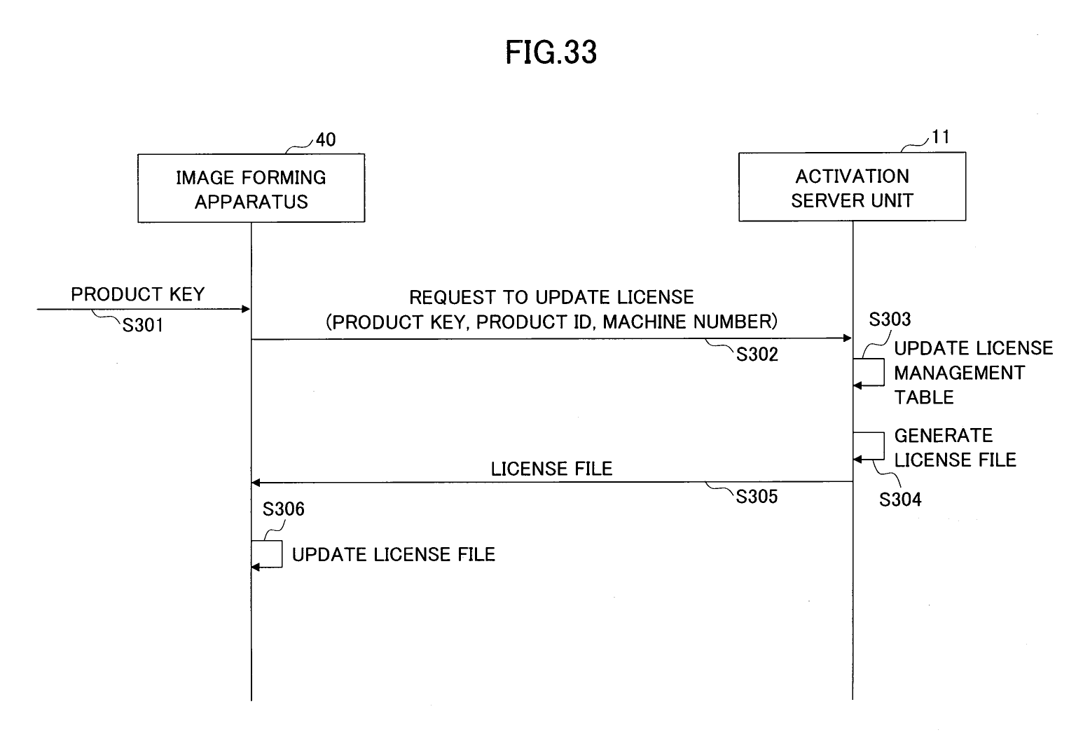

FIG. 33 is a sequence diagram for describing process procedures of a license update process.

To update a license, a user selects a function expansion management menu 513 in the function expansion setting menu screen page 510 (see FIG. 19) displayed on the operations panel 45. The UI control unit 426 causes the operations panel 45 to display a function expansion management screen page when the function expansion management menu 513 is selected.

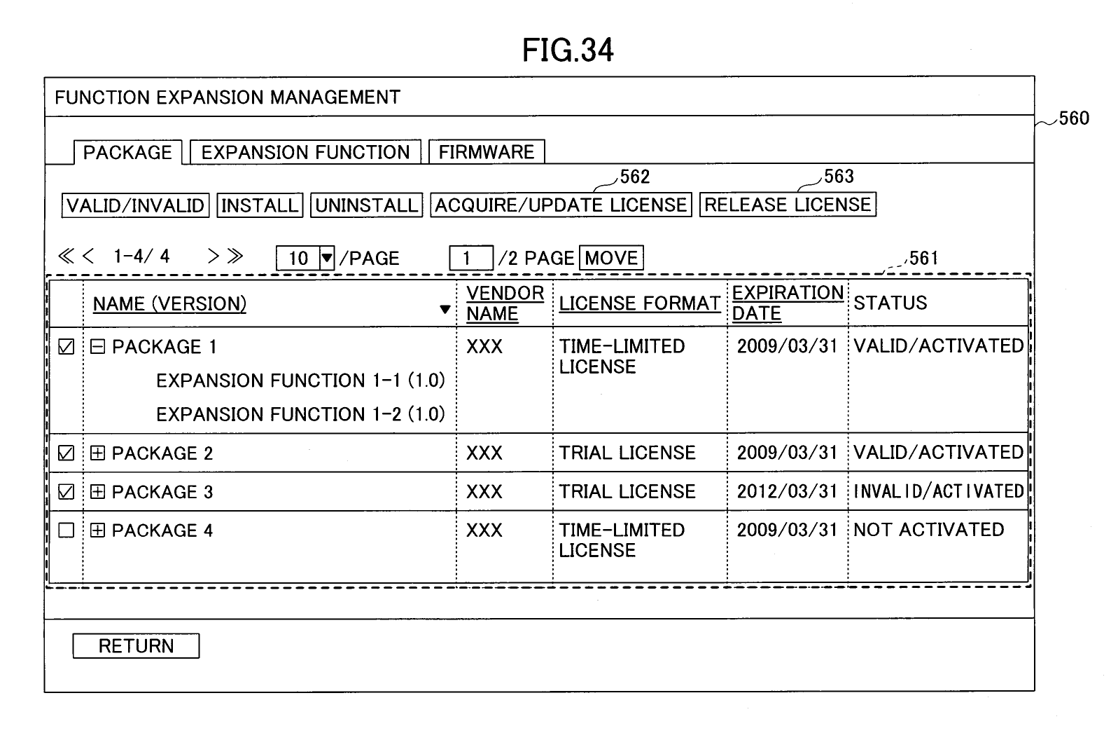

FIG. 34 illustrates a display example of a function expansion management screen page. A function expansion management screen page 560 has a sales package list display area 561. The sales package list display area 561 displays a list of sales packages installed in the image forming apparatus 40. The list has check buttons provided for each sales package. When a user ticks a check button of a sales package for which a license is to be updated, and a license acquire/update button 562 is selected, the UI control unit 426 causes the operations panel 45 to display a license acquire/update screen page.

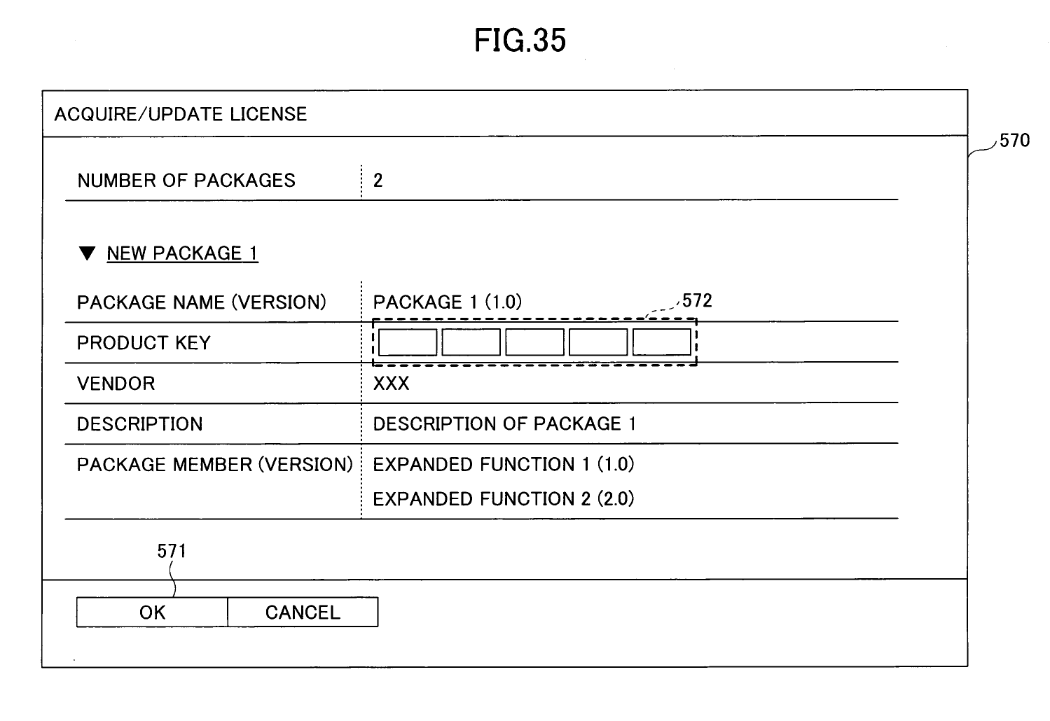

FIG. 35 illustrates a display example of a license acquire/update screen page. A license acquire/update screen page 570 has a product key enter field 572 for entering a product key for the sales package ticked in the function expansion management screen page 560. When a user enters a product key in the product key enter field 572 and selects an OK button 571 (step S301), the license update unit 422 specifies the entered product key, the product ID of the sale package for which the license is to be updated, and the machine number of the image forming apparatus 40 recorded in the ROM 413 or the HDD 414, and sends a request to update the license (a request to generate a new license file) to the license issue unit 115 of the activation server unit 11 (step S302).

The license issue unit 115 updates the license management table 121 in response to receiving the license update request (step S303). Specifically, when the license format of the record corresponding to the product key, the product ID and the machine number specified in the update request is a time-limited license, the license issue unit 115 updates the license expiration date and license issue date of the corresponding record. Furthermore, when the status of the record is “check in”, the license issue unit 115 updates the status to “check out”. In this update process, the new license expiration date is obtained by adding the license validity period of the record to either the license expiration date that is already registered or the present date, whichever the later date. Furthermore, the new license issue date is the year/month/date of the present date. When plural product IDs are specified, plural records are updated.

Next, the license issue unit 115 generates, for each updated record in the license management table 121, a license file 90 (see FIG. 28) including a product ID, a machine number, and an expiration date recorded in the corresponding record (step S304).

Next, the license issue unit 115 returns the generated license file 90 to the license update unit 422 (step S305). The license update unit 422 deletes the existing license file 90 for the sales package selected as an object for updating the license, and saves the received license file 90 in a predetermined storage area of the HDD 414 (step S306). Furthermore, the license update unit 422 updates the install information management table 427 based on the received license file 90. Specifically, the license update unit 422 updates the expiration date of the record corresponding to the product ID recorded in the install information management table 427, to the expiration date recorded in the received license file 90. Furthermore, the sales management unit 22 updates the activation flag of the record to a value indicating that the sales package is activated.

According to the above process, the user can continue to use the same sales package until the new expiration date.

Fees for updating a license are charged in the same manner as that when installing the sales package. That is to say, fees are charged based on information in the license management table 121 that is periodically acquired from the activation server unit 11 by the sales management unit 22 of the sales server 20. More specifically, when the license management table 121 includes a record including a license issue date that is later than the last time a fee was charged, a fee is charged for the license relevant to the corresponding record.

Next, a description is given of a process of updating a sales package (sales package update process). When a license is valid, a user can update an upgraded sales package.

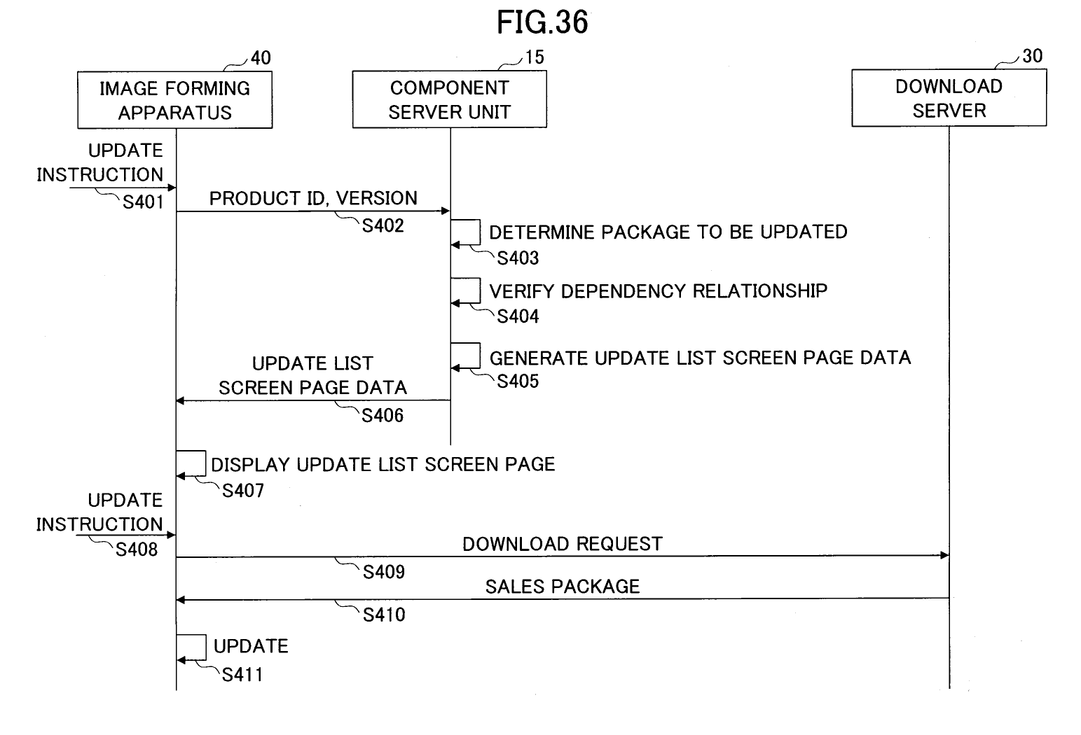

FIG. 36 is a sequence diagram for describing process procedures of a sales package update process. When an update menu 512 is selected in the function expansion setting menu screen page 510 displayed on the operations panel 45 (step S401), the package update unit 423 specifies the product IDs and versions of the sales packages installed in the image forming apparatus 40, and sends a request to update the sales packages to the package update support unit 153 of the component server unit 15 (step S402). The product IDs and versions of the sales packages are acquired from the install information management table 427.

The package update support unit 153 determines which sales packages can be updated (can be update candidates), based on the product IDs and versions specified in the received update request and the component management table 155 (step S403). Specifically, the package update support unit 153 determines whether there is a sales package (product ID) registered in the component management table 155 corresponding to a newer version than the received version. When there is a sales package registered in the component management table 155 corresponding to a newer version than the received version, the package update support unit 153 recognizes that the corresponding sales package can be an update candidate.

Next, the package update support unit 153 causes the dependency relationship determining unit 151 to verify the dependency relationship of the sales package determined to be an update candidate (step S404). Although the dependency relationship of the sales package has already been verified when installing the sales package, the dependency relationship is verified once again when the sales package is updated because the dependency relationship between sales packages may have changed due to upgrading. The process of verifying the dependency relationship at step S404 is the same as that performed when installing the sales package (see FIG. 29).

When there is no problem with the dependency relationship, the package update support unit 153 generates update list screen page data for displaying a screen page (update list screen page) used for selecting a sales package to be updated from among the sales packages that are update candidates (step S405). Next, the package update support unit 153 returns the generated update list screen page data to the package update unit 423 (step S406). When there is a problem with the dependency relationship, the same confirmation screen page data as that generated when installing the sales packages is generated for the sales packages that are update candidates, and the confirmation screen page data is returned to the package update unit 423.

Next, the package update unit 423 enters the received update list screen page data in the UI control unit 426. The UI control unit 426 causes the operations panel 45 to display an update list screen page based on the update list screen page data (step S407).

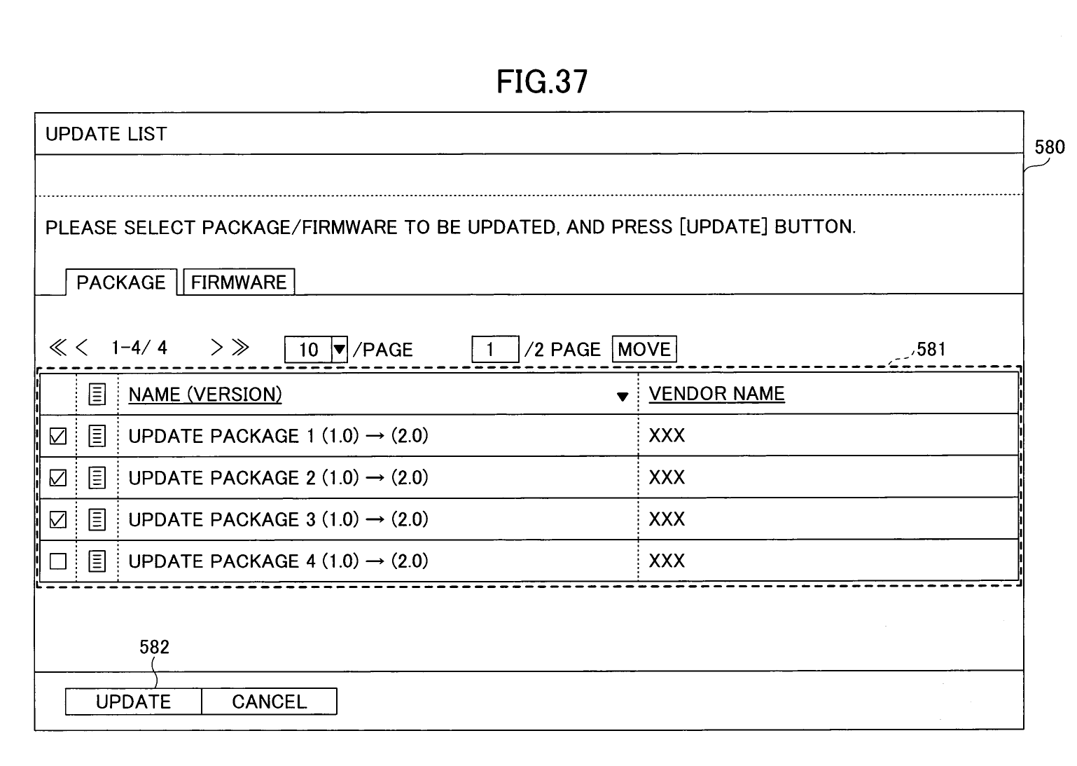

FIG. 37 illustrates a display example of an update list screen page. An update list screen page 580 includes an update package list display area 581. In the update package list display area 581, a list of sales packages that are upgraded is displayed. In the list, a check button is provided for each sales package.

When a user ticks check buttons of sales packages to be updated and an update button 582 is selected (step S408), the package update unit 423 specifies URLs for the selected sales packages to be updated, and sends a request to download the sales packages to the download process unit 31 of the download server 30 (step S409).

That is to say, the update list screen page data includes URLs of the sales packages that are update candidates. Furthermore, the update button 582 is associated with an instruction to send a download request specifying URLs of sales packages ticked (selected) in the update package list display area 581.

Next, the download process unit 31 acquires, from the sales package management unit 32, sales packages identified by the URLs specified in the received download request, and transfers the sales packages to the package update unit 423 (step S410). The package update unit 423 saves the received sales packages in a predetermined storage area in the HDD 414, to update the sales packages of old versions. Furthermore, the package update unit 423 updates the install information management table 427 based on the product IDs and versions recorded in the sales package information files stored in the received sales packages. Specifically, values of versions corresponding to the product IDs are updated in the deactivation unit 425.

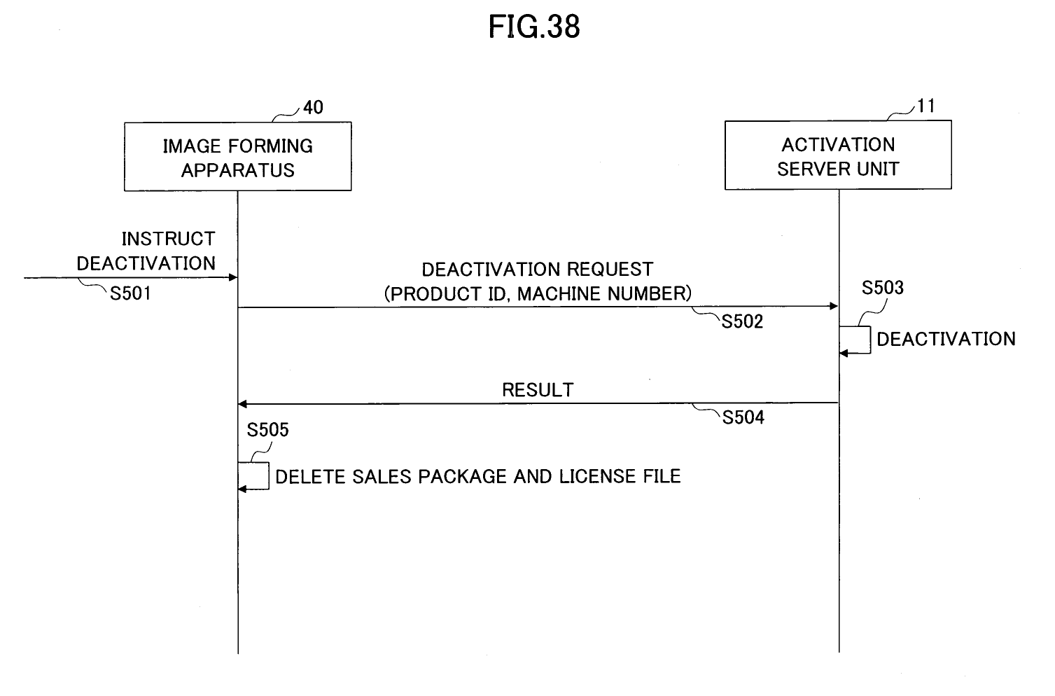

Next, a description is given of a deactivation process. FIG. 38 is a sequence diagram for describing process procedures of a deactivation process.

In step S501, the deactivation unit 425 receives a deactivation instruction entered by a user (step S501). The deactivation instruction is entered via the function expansion management screen page 560 (see FIG. 34). Specifically, in the sales package list display area 561 of the function expansion management screen page 560, when the sales package to be deactivated is ticked and a license release button 563 is selected, the deactivation unit 425 recognizes the ticked sales package as a deactivation object.

Next, the deactivation unit 425 specifies the product ID of the sales package to be deactivated and the machine number of the image forming apparatus 40, and sends a deactivation request (a request to release the license) to the deactivation unit 116 of the activation server unit 11 (step S502). In the license management table 121, the deactivation unit 116 changes the status of the record relevant to the specified product ID and machine number from “check out” to “check in”. That is to say, information indicating that the corresponding license is not used is recorded. Deactivation can be executed for a license whose status is “check out”. Therefore, when the status in the record of the deactivation object is not “check out”, the deactivation unit 116 determines that the process has failed.

Next, the deactivation unit 116 returns the deactivation process result (whether the process is successful) to the deactivation unit 425 of the image forming apparatus 40 (step S504). When the deactivation process is successful, the deactivation unit 425 deletes the sales package to be deactivated and the license file 90 of the sales package to be deactivated from the HDD 414 (step S505). The deactivation unit 425 deletes the record corresponding to the deleted sales package from the install information management table 427.

Accordingly, in the image forming apparatus 40, function packages included in the deactivated sales package cannot be used. Meanwhile, the license of the sales package has been released, and therefore the released license may be used in another image forming apparatus 40 according to need, as long as the license has not yet expired. That is to say, the deactivation process is particularly useful when the lease period of the image forming apparatus 40 ends, and a license of a sales package included in the image forming apparatus 40 is to be transferred to another image forming apparatus 40.

The deactivation process is automatically executed when the image forming apparatus 40 detects that there is a license that has expired.

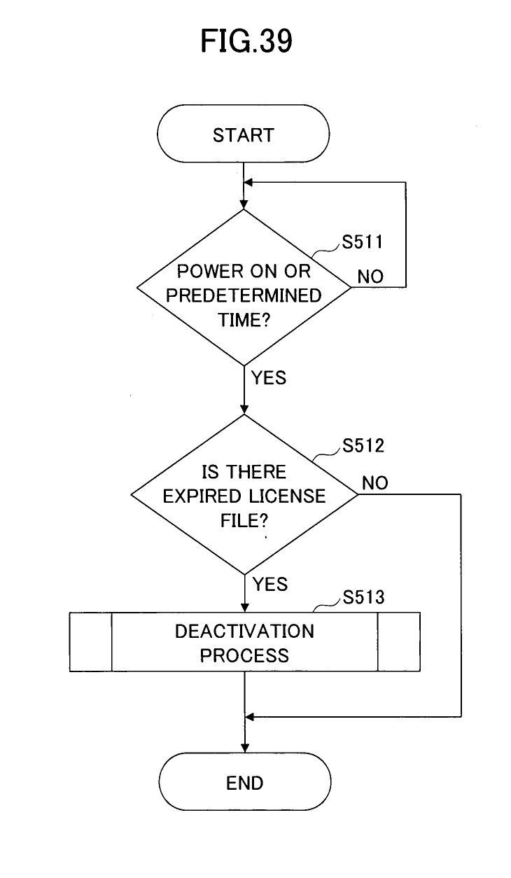

FIG. 39 is a flowchart for describing process procedures of a process of automatically executing deactivation in the image forming apparatus 40.

For example, when the image forming apparatus 40 is activated, or at a predetermined time that is set in advance (YES in step S511), the deactivation unit 425 checks the expiration dates of all license files 90 saved in the HDD 414 of the image forming apparatus 40 (step S512). Specifically, the deactivation unit 425 compares the expiration dates of license files 90 with the present time (date), and confirms whether there are any license files 90 that have expired. When there is a license file 90 that has expired (YES in step S512), the deactivation unit 425 executes the deactivation process described with reference to FIG. 38, for the product ID (sales package) recorded in the corresponding license file 90 (step S513).

As described above, according to the first embodiment, a user can easily instruct operations according to the guidance of screen pages displayed on the image forming apparatus 40, including updating licenses, updating sales packages, and deactivating sales packages.

Furthermore, as the entity of the sales package and the license are clearly separated, flexible operations are possible, such as updating only the license or updating (upgrading) only the sales package.

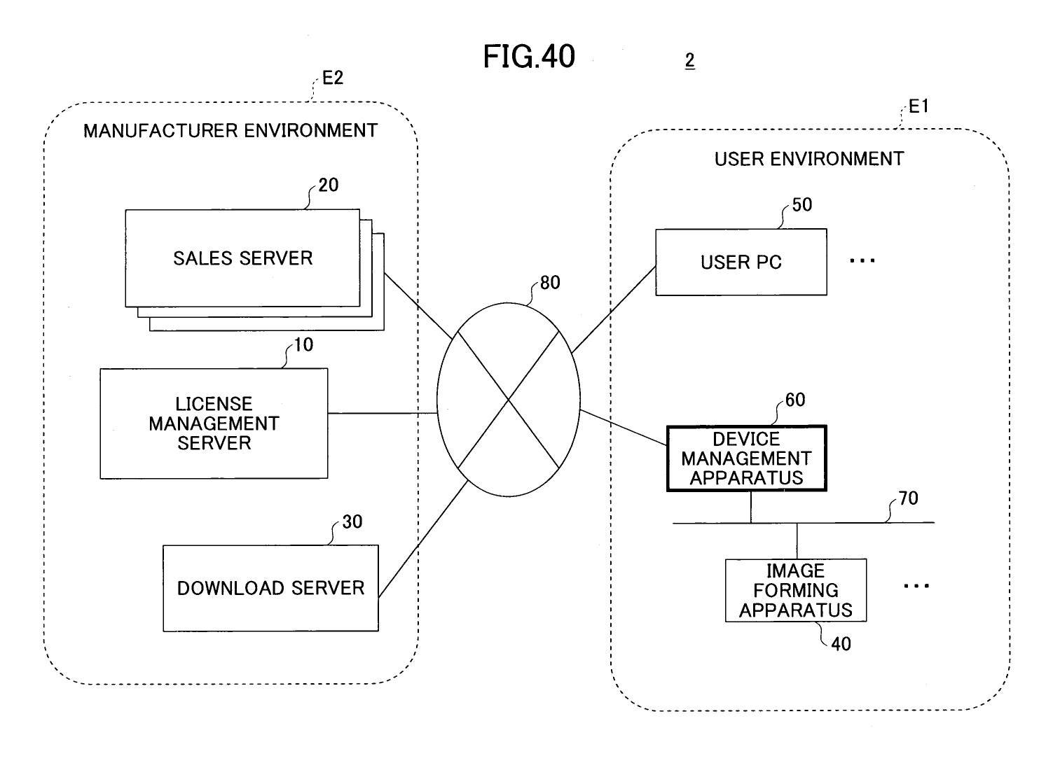

Next, a description is given of a second embodiment. FIG. 40 illustrates an example of a configuration of a device management system 2 according to a second embodiment. In FIG. 40, elements corresponding to those of FIG. 1 are denoted by the same reference numerals, and are not further described.

In FIG. 40, a device management apparatus 60 is added to the user environment E1. The device management apparatus 60 is a computer such as a PC (personal computer) that can collectively perform the operations of acquiring and installing a component to be operated in the image forming apparatus 40 and a license (usage authority) of the component. The hardware configuration of the device management apparatus 60 may be the same as that shown in FIG. 6. However, the device management apparatus 60 includes a display device such as a liquid crystal display and an input device such as a keyboard and a mouse. The device management apparatus 60 is connected to the image forming apparatuses 40 via a network 80 (wired or wireless) such as LAN (Local Area Network). Furthermore, the user PC 50 may also be connected to the network 80. Furthermore, the user PC 50 may also serve as the device management apparatus 60.

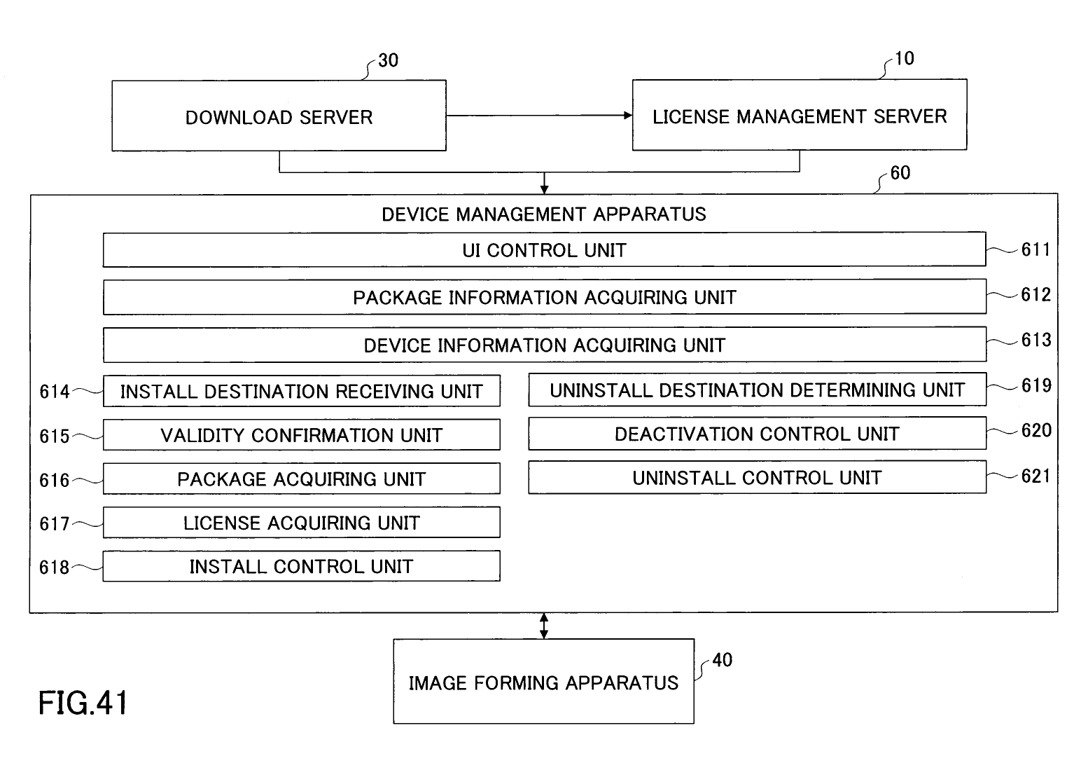

FIG. 41 illustrates an example of a functional configuration of the device management apparatus 60 according to the second embodiment.

As shown in FIG. 41, the device management apparatus 60 includes a UI control unit 611, a package information acquiring unit 612, a device information acquiring unit 613, an install destination receiving unit 614, a validity confirmation unit 615, a package acquiring unit 616, a license acquiring unit 617, an install control unit 618, an uninstall destination determining unit 619, a deactivation control unit 620, and an uninstall control unit 621.

The UI control unit 611 receives an instruction given by a user (an instruction to install or uninstall a sales package, etc.). The package information acquiring unit 612 acquires, from the license management server 10, configuration information of the sales package selected as the object to be installed or uninstalled. The device information acquiring unit 613 acquires device information from the image forming apparatus 40. The device information includes information relevant to sales packages and firmware installed in the image forming apparatus 40. The install destination receiving unit 614 receives, from a user, a specification of an image forming apparatus 40 into which the sales package is to be installed (install destination). The validity confirmation unit 615 causes the dependency relationship determining unit 151 of the license management server 10 to verify the validity of installing the sales package selected as an install object in the image forming apparatus 40 specified as the install destination.

The package acquiring unit 616 downloads (acquires) the sales package to be installed from the download server 30. The license acquiring unit 617 acquires the license file 90 relevant to the sales package to be installed, from the license management server 10. The install control unit 618 sends the sales package and the license file 90 to the image forming apparatus 40.

The uninstall destination determining unit 619 determines the image forming apparatus 40 in which the sales package selected as an uninstall object, is installed. The deactivation control unit 620 sends a request to delete the license file 90, and requests the license management server 10 to release the license relevant to the corresponding license file 90. The uninstall control unit 621 requests the image forming apparatus 40 to uninstall the sales package.

The functional configurations of the other devices such as the license management server 10, the download server 30, and the image forming apparatus 40 may be the same as those of the first embodiment.

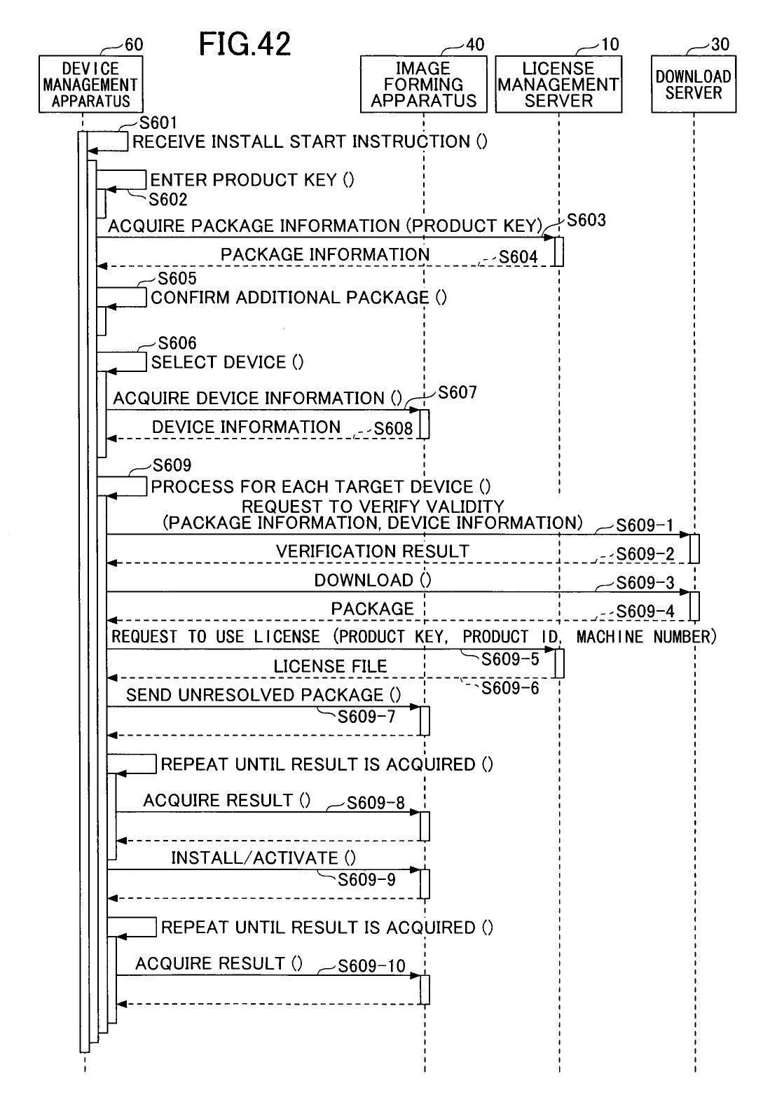

A description is given of process procedures performed by the device management system 2. FIG. 42 is a sequence diagram for describing process procedures of installing and activating a sales package according to the second embodiment. In FIG. 42, it is assumed that a user of the image forming apparatus 40 has purchased any one of the articles relevant to the sales package, and has obtained the product key of the article. The method of purchasing an article and the method of obtaining a product key may be the same as those of the first embodiment. In FIG. 42, the device management apparatus 60 is the operation target.

When an instruction to start installing a sales package entered in an initial screen page displayed on a display device is received, the UI control unit 611 of the device management apparatus 60 causes the display device to display a product key enter screen page (step S601). When a user enters a product key of the sales package to be installed (hereinafter, “current sales package”) in the product key enter screen page (step S602), the package information acquiring unit 612 specifies the entered product key and sends a request to acquire package information relevant to the product key to the install support unit 152 of the license management server 10 (step S603).

When the request to acquire package information is received, the install support unit 152 causes the product key validation unit 113 to confirm the validity of the product key, by performing the same procedures as those of step S153 through S155 of FIG. 18.

When it is determined that the product key is valid, the install support unit 152 acquires information registered for the received product key from the component management table 155 (see FIG. 22), and returns the acquired information as package information to the package information acquiring unit 612 (step S604). Accordingly, the package information includes at least the product ID that is associated with the product key (i.e., the product ID of the current sales package). Furthermore, when the product key is relevant to a group license or a volume license, information relevant to plural IDs (plural records) is included in the package information.

When the package information acquiring unit 612 receives the package information, the UI control unit 611 of the device management apparatus 60 causes the display device to display a screen page (confirmation screen page) including the received package information, and prompts a user to confirm the contents of the current sales package and the contents of the license (step S605).

When the user enters an instruction to continue the install operation (for example, when an OK button in the confirmation screen page is pressed), the install destination receiving unit 614 causes the display device to display a device selection screen page including a list of image forming apparatuses 40, and prompts a user to select the image forming apparatus 40 into which the current sales package is to be installed (step S606). In the device selection screen page, plural image forming apparatuses 40 may be selected. In the device selection screen page, image forming apparatuses 40 whose IP addresses and host names are stored in the storage device in advance are displayed. Alternatively, the device information acquiring unit 613 may issue a broadcast in the network 80, to dynamically search for image forming apparatuses 40 connected to the network 80, and display the host names of the search found image forming apparatuses 40 in the device selection screen page.

Next, the device information acquiring unit 613 sends a request to acquire device information, to the image forming apparatuses 40 selected in the device selection screen page (step S607). The install unit 421 of each image forming apparatus 40, which has received the request to acquire device information, acquires information recorded in the install information management table 427 (see FIG. 24), and returns device information to the device information acquiring unit 613. The device information includes the acquired information and the machine number of the corresponding image forming apparatus 40 (step S608).

The subsequent step S609 is a loop process that is executed for each image forming apparatus 40 for which device information has been acquired (selected in the device selection screen page). In the loop process, the image forming apparatus 40 that is the process target is hereinafter referred to as a “current device”.

In step S609-1, the validity confirmation unit 615 sends, to the license management server 10, a validity verification request including the device information of the current device and package information acquired by the package information acquiring unit 612. In this example, “validity” refers to the validity of installing the function package included in the current sales package, in the current device. When a validity verification request is received, the dependency relationship determining unit 151 of the license management server 10 performs the same process as that described with reference to FIG. 29, to verify the dependency relationship of the current sales package. When there is no problem with the dependency relationship, the dependency relationship determining unit 151 determines that it is valid to install the function package. When there is a problem with the dependency relationship, the dependency relationship determining unit 151 determines that it is invalid to install the function package.

Next, the dependency relationship determining unit 151 returns the result of verifying validity to the validity confirmation unit 615 (step S609-2). When it is determined that it is valid to install the function package, and the dependency package is not installed in the current device, the verification result includes information recorded in the component management table 155 regarding the corresponding dependency package (hereinafter, “non-installed dependency package”). This information corresponds to an instruction to acquire the non-installed dependency package.

When a verification result indicating that it is valid to install the function package is received, the package acquiring unit 616 sends a request to download the current sales package to the download server 30, based on a download path (URL) included in the package information of the current sales package (step S609-3). In response to the download request, the download process unit 31 acquires, from the sales package management unit 32, a sales package identified by the URL specified in the download request, and returns the acquired sales package (step S609-4). When there are plural current sales packages, the download operation (steps S609-3 and S609-4) is repeated plural times. In step S609-2, when a verification result including package information of the non-installed dependency package is received, the download operation is also performed for the non-installed dependency package. A case where there are plural current packages corresponds to a case where, for example, the product key entered at step S601 is relevant to a group license, or plural product keys are entered at step S601.

Next, the license acquiring unit 617 specifies the product key entered at step S601, the product ID of the current sales package, and the machine number of the current device, and sends a request to use the license to the license management server 10 (step S609-5).

The license issue unit 115 of the license management server 10 generates the license file 90 by executing the same process as that of FIG. 31, and returns the generated license file 90 to the license acquiring unit 617 (step S609-6).

The license acquiring unit 617 executes step S609-5 when the package acquiring unit 616 has successfully acquired (downloaded) the sales package. That is to say, the license acquiring unit 617 does not acquire the license file 90 when the sales package has not been successfully acquired. When the sales package cannot be acquired, the sales package cannot be installed. Nevertheless, if a license file 90 corresponding to this sales package is acquired, a license is used for a sales package that is not actually used, which is detrimental to the user.

Next, when the non-installed dependency package is acquired in step S609-4, the install control unit 618 sends the non-installed dependency package to the current device, and requests the current device to install the non-installed dependency package (step S609-7). The install unit 421 of the current device installs the non-installed dependency package, and records information (product ID, etc.) of the non-installed dependency package in the install information management table 427.

Next, the install control unit 618 inquires the install results of the non-installed dependency package from the current device (step S609-8). The inquiring (poling) is repeated until the installing operation is completed in the current device and an install result is returned.

The non-installed dependency package is installed first to avoid a failure in installing the sales package, which may occur when a component on which the sales package depends is not installed.

Next, the install control unit 618 sends the sales package acquired at step S609-4 (current sales package) and the license file 90 acquired at step S604-6 to the current device, and requests the current device to install and activate the sales package (step S609-9). The install unit 421 of the current device executes the process described with reference to FIG. 18, for the received sales package and license file 90. As a result, the sales package can be used in the current device.

Next, the install control unit 618 inquires the install results of the sales package from the current device (step S609-10). The inquiring (poling) is repeated until the installing operation is completed in the current device and an install result is returned.

Next, a description is given of a process of uninstalling and deactivating a sales package (releasing a license).

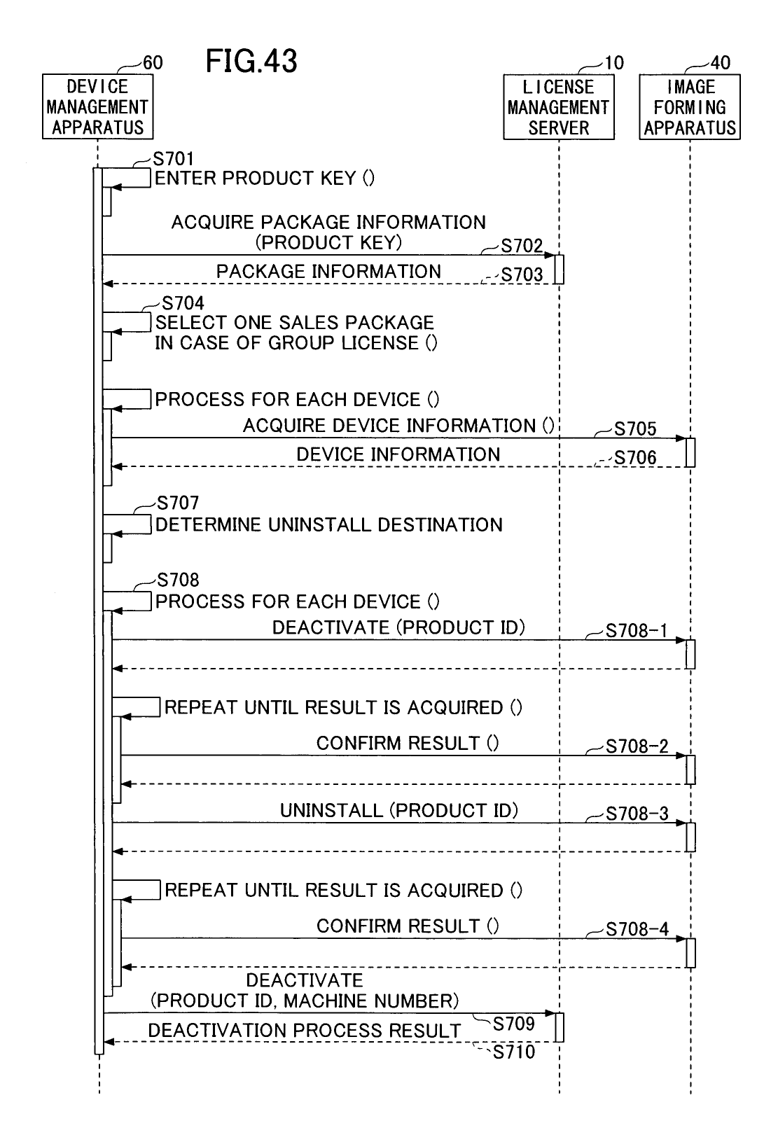

FIG. 43 is a sequence diagram for describing process procedures of uninstalling and deactivating a sales package according to the second embodiment.

In step S701, the UI control unit 611 of the device management apparatus 60 receives a product key of the uninstall object, which is entered by a user in an uninstall screen page displayed on the display device. Next, the package information acquiring unit 612 specifies the entered product key and sends, to the license management server 10, a request to acquire package information relevant to the product key (step S702).

Next, the component management unit 154 of the license management server 10 executes the same process as that executed in accordance with step S603 of FIG. 42, and returns, to the package information acquiring unit 612, package information of the sales package relevant to the received product key (step S703). When the product key is relevant to a group license, package information of plural sales packages is returned.

When the product key is relevant to a group license, i.e., when package information relevant to plural sales packages is received, the UI control unit 611 causes the display device to display a sales package selection screen page including list information of the sales packages, and prompts a user to select a sales package to be uninstalled (step S704). Hereinafter, the selected sales package is referred to as a “current sales package”.

Next, the device information acquiring unit 613 sends a request to acquire device information to the image forming apparatuses 40 (step S705). In response to receiving a request to acquire device information, the license check unit 424 of each image forming apparatus 40 acquires information recorded in the install information management table 427, and returns, to the device information acquiring unit 613, information including the acquired information and the machine number of the corresponding image forming apparatus AO, as the device information (step S706).

Next, the uninstall destination determining unit 619 cross-checks the package information acquired in step S703 with the device information acquired from the image forming apparatuses 40 at step S706, and determines the image forming apparatus 40 in which the sales package relevant to the package information is installed (step S707). Specifically, the image forming apparatus 40 relevant to the device information including the product ID (product ID of the sales package) included in the package information, is determined to be the image forming apparatus 40 in which the sales package is installed (i.e., the image forming apparatus 40 that is an uninstall destination of the sales package).

The subsequent step S708 is a loop process that is executed for each image forming apparatus 40 that is an uninstall destination of the sales package. In the loop process, the image forming apparatus 40 that is the process target is hereinafter referred to as a “current device”.

In step S708-1, the deactivation control unit 620 specifies the product ID of the current sales package, and sends a deactivation request (a request to delete the license file 90) to the current device. In response to the request, the license check unit 424 of the current device deletes the license file 90 relevant to the specified product ID.

Next, the deactivation control unit 620 inquires the result of the process of deleting the license file 90 from the current device (step S708-2). The inquiring (poling) is repeated until the process of deleting the license file 90 is completed in the current device and a result of the deleting process is returned.

Next, the uninstall control unit 621 specifies the product ID of the current sales package, and sends an uninstall request (a request to delete the sales package) to the current device (step S708-3). In response to the request, the license check unit 424 of the current device uninstalls (deletes) the sales package relevant to the specified product ID.

Next, the deactivation control unit 620 inquires the result of uninstalling the current sales package from the current device (step S708-4). The inquiring (poling) is repeated until the uninstalling operation is completed in the current device and an uninstall result is returned.

When step S708 has been executed for all of the image forming apparatuses 40 that are tarrets of the process of uninstalling the sales package, the deactivation control unit 620 specifies the product ID of the current sales package and the machine numbers of the image forming apparatuses 40, and sends a deactivation request (a request to release the license) to the deactivation unit 116 of the license management server 10 (step S709). The deactivation unit 116 executes the process as described with reference to step S503 of FIG. 38. As a result, the status of the license relevant to the specified product ID and machine number is changed to “check in”. Next, the deactivation unit 116 returns a deactivation process result (whether the process is successful) to the deactivation control unit 620 of the device management apparatus 60 (step S710).

As described above, the device management apparatus 60 according to the second embodiment can collectively perform operations of installing and activating sales packages (starting to use a license) for plural image forming apparatuses 40. Therefore, in the user environment E1 including multiple image forming apparatuses 40, the work load of the user can be significantly reduced.

In the present embodiment, the image forming apparatus 40 is described as an example of a device; however, the present invention is not so limited. The present invention can be effectively applied to any device in which a program can be installed.

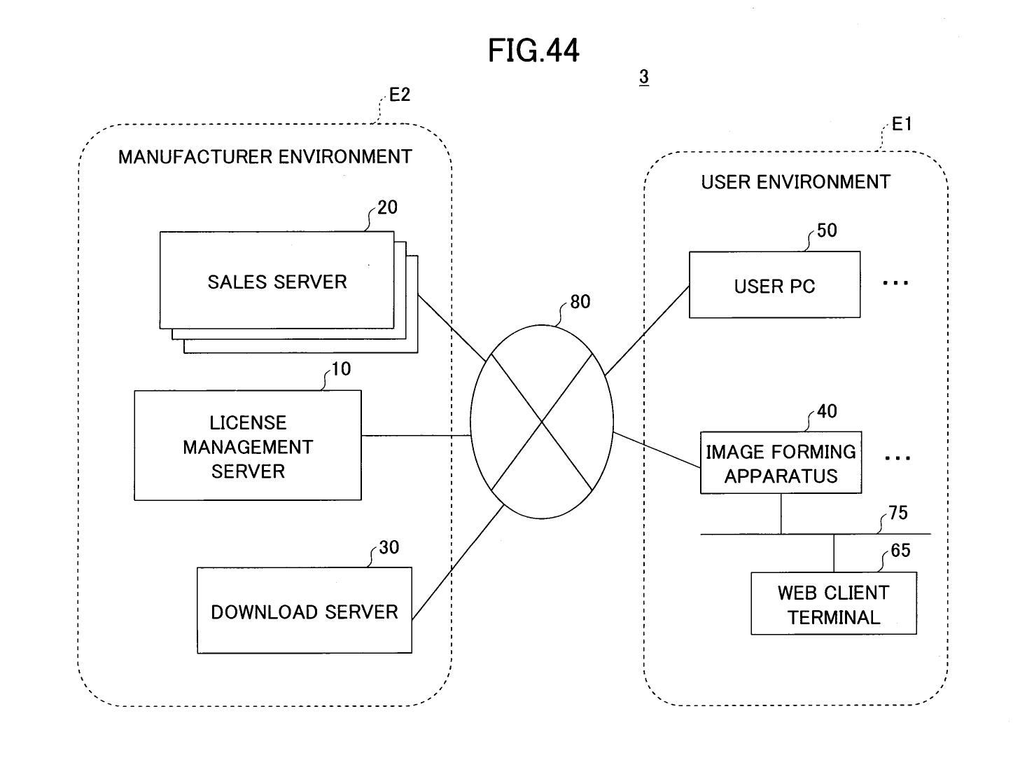

Next, a description is given of a third embodiment. FIG. 44 illustrates an example of a configuration of a device management system 3 according to a third embodiment. In FIG. 44, elements corresponding to those of FIG. 1 are denoted by the same reference numerals, and are not further described.

In FIG. 44, a web client terminal 65 is added to the user environment E1. The web client terminal 65 is a computer such as a PC (personal computer) or an electronic device provided with a web browser. The web client terminal 65 may have the same hardware configuration as that illustrated in FIG. 6. However, the web client terminal 65 includes a display device such as a liquid crystal display and an input device such as a keyboard and a mouse. The web client terminal 65 is connected to the image forming apparatuses 40 via a network 80 (wired or wireless) such as LAN (Local Area Network). Furthermore, the user PC 50 may also be connected to the network 80. Furthermore, the user PC 50 may also serve as the web client terminal 65.

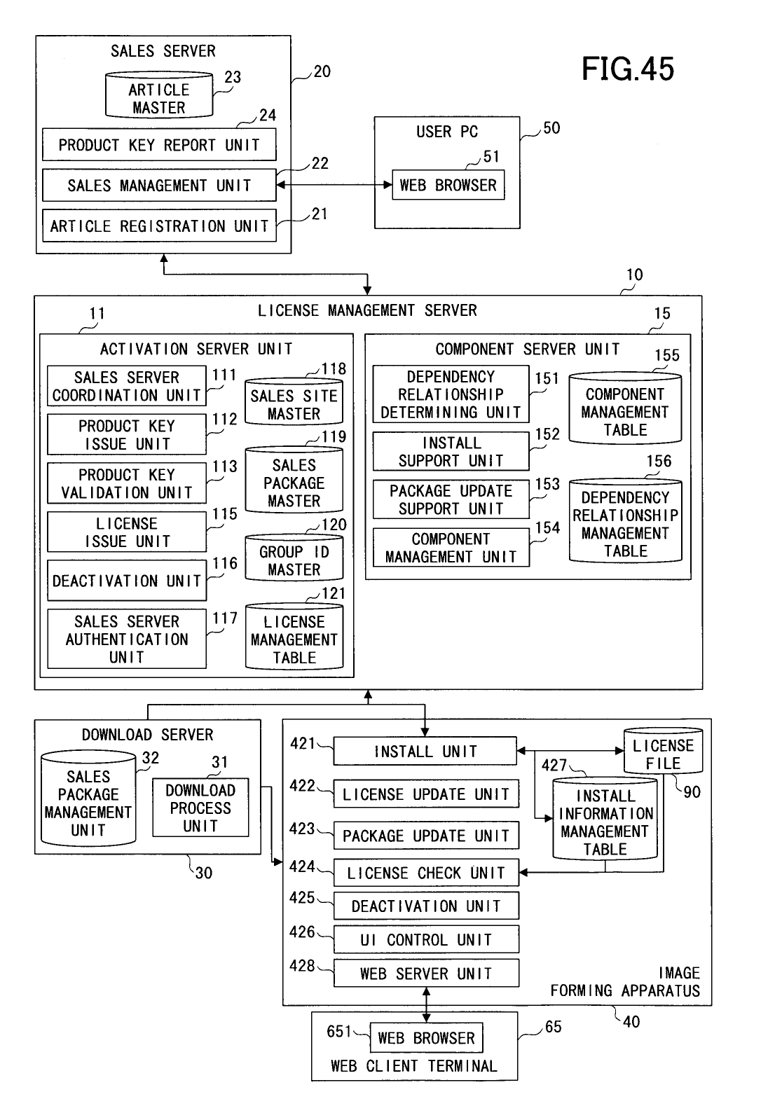

FIG. 45 illustrates an example of a functional configuration of the device management system 3 according to the third embodiment. In FIG. 45, elements corresponding to those of FIG. 5 are denoted by the same reference numerals, and are not further described.

In FIG. 45, the image forming apparatus 40 further includes a web server unit 428. The web server unit 428 executes a process for causing the web client terminal 65 to display the screen pages displayed on the operations panel 45 by the UI control unit 426 in the first embodiment. Specifically, the web server unit 428 sends HTML data of various screen pages to the web client terminal 65.

Meanwhile, the web client terminal 65 includes a web browser 651. The web browser 651 receives HTML data sent from the web server unit 428, and causes the display device of the web browser 651 to display various screen pages based on the HTML data.

That is to say, with the device management system 3 according to the third embodiment, instead of entering operations with the operations panel 45 as in the first embodiment, the user can enter operations from a remote location with the use of the web client terminal 65. Specifically, the user can enter the instructions at steps S151, S159, and S165 in the sequence diagram of FIG. 18, with a screen page displayed by the web browser 651. Accordingly, in the third embodiment, the web server unit 428 corresponds to an example of an input unit for receiving license keys entered by a user.

In the above embodiments, the license management server 10, the sales server 20, and the download server 30 are described as separate devices. However, the license management server 10 may include the functions of at least one of the sales server 20 and the download server 30.

According to an embodiment of the present invention, there is provided an information processing device, a program installation support method, and a computer-readable recording medium that can appropriately support the operation of installing a program.

The present invention is not limited to the specific embodiments described herein, and variations and modifications may be made without departing from the scope of the present invention.

The present application is based on Japanese Priority Application No. 2010-127686 filed on Jun. 3, 2010 with the Japan Patent Office, the entire contents of which are hereby incorporated by reference.

1. An information processing device that performs communications via a network with a management device storing dependency information indicating a dependency relationship between programs, the information processing device comprising:
a sending unit that sends, to the management device, identification information of a program to be downloaded;
a receiving unit that receives, from the management device, install possibility information indicating whether the program to be downloaded can be installed in the information processing device, the install possibility information being determined based on the dependency information; and
a display control unit that causes a display unit to display a screen page indicating whether the program to be downloaded can be installed in the information processing device based on the install possibility information, before downloading the program to be downloaded.

2. The information processing device according to claim 1, further comprising:
an installed program information storing unit that stores installed program information including the identification information, the installed program information being stored for each program that is installed in the information processing device, wherein
the sending unit sends, to the management device, the installed program information and the identification information of the program to be downloaded, and
the receiving unit receives, from the management device, the install possibility information that is determined according to whether a program depended upon by the program to be downloaded is a program relevant to the installed program information, based on the dependency information.

3. The information processing device according to claim 1, further comprising:
a download unit that downloads the program to be downloaded, which can be installed in the information processing device based on the install possibility information.

4. The information processing device according to claim 2, wherein
the display control unit causes the display unit to display the screen page that further indicates whether the program depended upon by the program to be downloaded can be installed in the information processing device based on the install possibility information.

5. A program installation support method performed by an information processing device that performs communications via a network with a management device storing dependency information indicating a dependency relationship between programs, the program installation support method comprising:
sending, to the management device, identification information of a program to be downloaded;
receiving, from the management device, install possibility information indicating whether the program to be downloaded can be installed in the information processing device, the install possibility information being determined based on the dependency information; and
causing a display unit to display a screen page indicating whether the program to be downloaded can be installed in the information processing device based on the install possibility information, before downloading the program to be downloaded.

6. A non-transitory computer-readable recording medium storing a program installation support program that causes an information processing device to execute a procedure, the information processing device performing communications via a network with a management device storing dependency information indicating a dependency relationship between programs, the procedure comprising:
sending, to the management device, identification information of a program to be downloaded;
receiving, from the management device, install possibility information indicating whether the program to be downloaded can be installed in the information processing device, the install possibility information being determined based on the dependency information; and
causing a display unit to display a screen page indicating whether the program to be downloaded can be installed in the information processing device based on the install possibility information, before downloading the program to be downloaded.

7. The program installation support method according to claim 5, further comprising:
storing installed program information including the identification information, the installed program information being stored for each program that is installed in the information processing device, wherein
sending, to the management device, the installed program information and the identification information of the program to be downloaded, and
receiving, from the management device, the install possibility information that is determined according to whether a program depended upon by the program to be downloaded is a program relevant to the installed program information, based on the dependency information.

8. The program installation support method according to claim 5, further comprising:
downloading the program to be downloaded, which can be installed in the information processing device based on the install possibility information.

9. The program installation support method according to claim 5, wherein
the display control unit causes the display unit to display the screen page that further indicates whether the program depended upon by the program to be downloaded can be installed in the information processing device based on the install possibility information.

10. The non-transitory computer-readable recording medium according to claim 6, the procedure further comprising:
storing installed program information including the identification information, the installed program information being stored for each program that is installed in the information processing device, wherein
sending, to the management device, the installed program information and the identification information of the program to be downloaded, and
receiving, from the management device, the install possibility information that is determined according to whether a program depended upon by the program to be downloaded is a program relevant to the installed program information, based on the dependency information.

11. The non-transitory computer-readable recording medium according to claim 6, the procedure further comprising:
downloading the program to be downloaded, which can be installed in the information processing device based on the install possibility information.

12. The non-transitory computer-readable recording medium according to claim 6, wherein
the display control unit causes the display unit to display the screen page that further indicates whether the program depended upon by the program to be downloaded can be installed in the information processing device based on the install possibility information.
